(19) United States
(12) Patent Application Publication
(10) Pub. No.: US 2026/0127565 A1
(43) Pub. Date: May 7, 2026

(54) SYSTEM AND METHOD FOR AUTOMATICALLY MANAGING RESOURCES AND TRANSFERRING ASSETS

(71) Applicants: MEYSAM NAYEBI, TEHRAN (IR); MAHDI NAYEBI, TEHRAN (IR); AMIR HOSSEIN GHALE NAYEBI, TEHRAN (IR); MEYSAM MADANI, TEHRAN (IR)

(72) Inventors: MEYSAM NAYEBI, TEHRAN (IR); MAHDI NAYEBI, TEHRAN (IR); AMIR HOSSEIN GHALE NAYEBI, TEHRAN (IR); MEYSAM MADANI, TEHRAN (IR)

(21) Appl. No.: 19/342,674

(22) Filed: Sep. 29, 2025

Related U.S. Application Data
(60) Provisional application No. 63/716,723, filed on Nov. 5, 2024.

(51) Int. Cl. G06Q 20/10; G06F 21/10; G06F 40/284; G06Q 30/0201

(52) U.S. Cl. CPC G06Q 20/10; G06F 21/108; G06F 40/284; G06Q 30/0206

(57) ABSTRACT

In accordance with some embodiments herein, a method is provided. The method includes determining a first resource associated with a first farm, wherein the first resource is a first type of resource, generating a first token for the first type of resource, allocating the first token to the first farm, and/or determining a first contract between the first farm and a first pool. The method includes allocating the first resource to the first customer request based upon the first contract responsive to a first customer request associated with a first service performable by the first type of resource. The method includes determining, using a first decentralized consensus mechanism, a first value associated with fulfillment of the first customer request via performance of the first service by the first resource. The method includes executing a first transfer of a first asset to the first farm based upon the first value.

### RELATED APPLICATION

This application claims the benefit of U.S. Provisional Patent Application No. 63/716,723, filed Nov. 5, 2024, which is incorporated herein by reference in its entirety.

### BACKGROUND

Various sectors, including transportation, services, and customer-focused industries are associated with emerging technologies. Providing secure, transparent, and efficient frameworks for investment, service delivery, and ecosystem growth may result in greater efficiency and reduced risk of investment.

### BRIEF DESCRIPTION OF DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 illustrates a flow chart of a method for automatically managing resources and/or transferring assets, in accordance with some embodiments.

FIG. 2 illustrates a plurality of farms associated with resources, in accordance with some embodiments.

FIG. 3 illustrates allocation of a first token and a second token to a first farm, in accordance with some embodiments.

FIG. 4 illustrates a plurality of contracts associated with a plurality of farms and a plurality of pools, in accordance with some embodiments.

FIG. 5 illustrates allocation of a first resource to a first customer request associated with a first service performable by a first resource of a first farm, in accordance with some embodiments.

FIG. 6 illustrates allocation of a first resource to a first customer request associated with a first service performable by a first resource of a first farm, in accordance with some embodiments.

FIG. 7 illustrates interactions of a financing entity, a first pool, and/or a first farm, in accordance with some embodiments.

FIG. 8 illustrates farms associated with a first pool and a second pool changing from a first time to a second time, in accordance with some embodiments.

FIG. 9 illustrates a customer device displaying a pool selection interface and/or a service selection interface, in accordance with some embodiments.

FIG. 10 illustrates representations of pools in an ecosystem and/or farms associated with the pools, in accordance with some embodiments.

FIG. 11 illustrates a representation of customers and/or users of an ecosystem, in accordance with some embodiments.

FIG. 12 illustrates an environment in which a system and/or an ecosystem operate, in accordance with some embodiments.

FIG. 13 illustrates an exemplary computer-readable medium comprising processor-executable instructions, wherein the processor executable instructions may be configured to embody one or more of the provisions set forth herein.

FIG. 14 illustrates an exemplary computing environment in which one or more of the provisions set forth herein may be implemented.

### DETAILED DESCRIPTION

Subject matter will now be described more fully hereinafter with reference to the accompanying drawings, which form a part hereof, and which show, by way of illustration, specific example embodiments. This description is not intended as an extensive or detailed discussion of known concepts. Details that are known generally to those of ordinary skill in the relevant art may have been omitted, or may be handled in summary fashion.

The following subject matter may be embodied in a variety of different forms, such as methods, devices, components, and/or systems. Accordingly, this subject matter is not intended to be construed as limited to any example embodiments set forth herein. Rather, example embodiments are provided merely to be illustrative.

The present disclosure relates to systems and methods for creating and/or managing an integrated ecosystem with farms, resources, pools and/or other components using a blockchain-based infrastructure. The ecosystem may simplify communications between farms, pools and/or customers of services, enhance transparency, and/or improve efficiency. The ecosystem may enable more secure investments, fairer value distribution, and/or transparent monitoring of asset use. In some examples, a farm may represent a collection of resources, and/or multiple farms may be combined in a pool. The ecosystem may enable pools to use the collective strength of farms to efficiently serve customers at scale, thereby enabling customers to gain access to reliable cost-effective services, farms to gain income from their resources, and/or pools to achieve scalable growth. It may be appreciated that the ecosystem may provide for transparent and/or simplified financing options, decentralized governance structure for resource allocation, and/or may allow entities to transparently generate income from their resources.

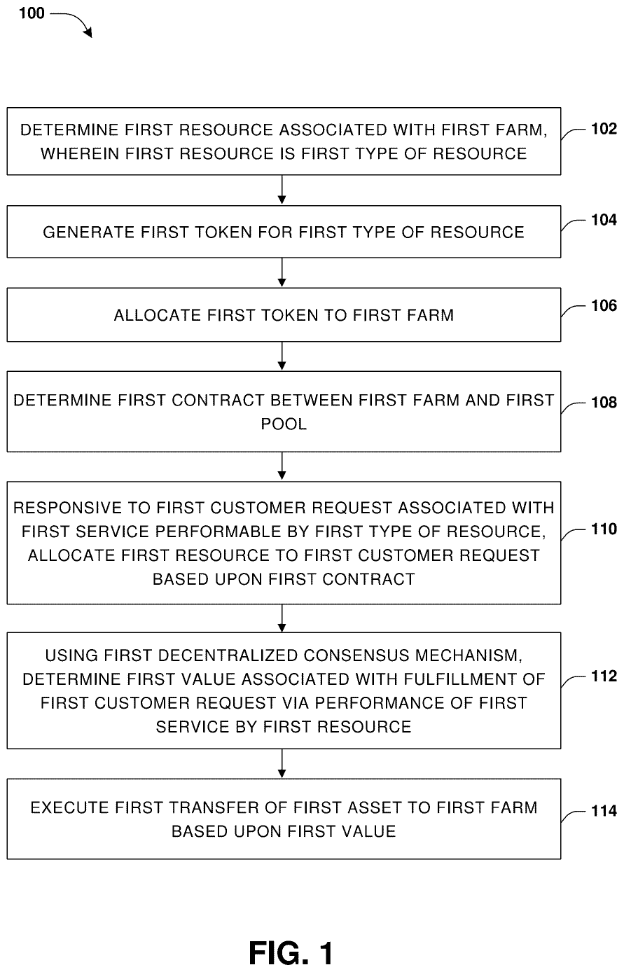

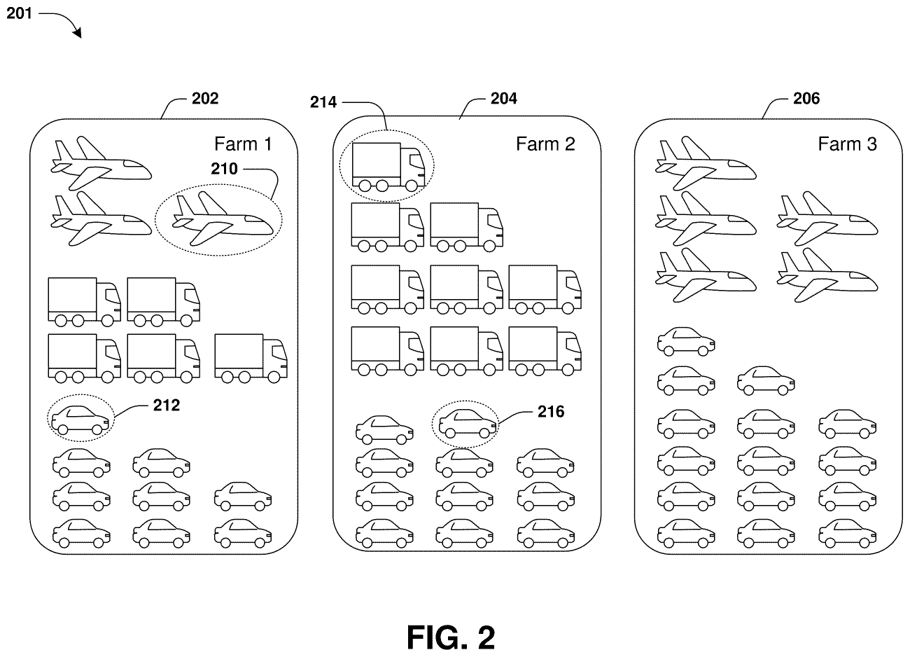

An embodiment of managing resources and/or transferring assets is illustrated by an example method 100 of FIG. 1, and is further described in conjunction with system 201 of FIGS. 2-12. At 102 of FIG. 1, a first resource 212 (shown in FIG. 2) associated with a first farm 202 may be determined. The first resource 212 may be a first type of resource. The first type of resource may be a car (e.g., a self-driving car or a non-self-driving car) and/or a car of a defined type, make, year and/or model. Embodiments are contemplated in which the first type of resource comprises other type of ground vehicle, such as at least one of a motorcycle, a scooter, a bus, a truck, a van, an all-terrain vehicle (ATV), a utility task vehicle (UTV), a tram, a bulldozer, an excavator, a forklift, a golf cart, a mobility scooter, a wagon, etc. Embodiments are contemplated in which the first type of resource comprises a type of sea transport vessel, such as at least one of a cargo ship, a container ship, a bulk carrier, an oil tanker, a passenger ship, a ferry, a cruise ship, an ocean liner, a submarine, an amphibious ship, a fishing boat, a trawler, a seiner, a research vessel, a service vessel, a tugboat, a dredger, a cable-laying ship, a supply ship, a yacht, a sailboat, a speedboat, a motorboat, a catamaran, a dinghy, a canoe, a kayak, etc. Embodiments are contemplated in which the first type of resource comprises a type of air vehicle, such as at least one of an airplane, a helicopter, a drone, a glider, a hot air balloon, an airship, a fighter jet, a seaplane, an ultralight aircraft, a tiltrotor aircraft, etc. Embodiments are contemplated in which the first type of resource comprises a type of space vehicle, such as at least one of a crewed spacecraft, a cargo spacecraft, a satellite, a space shuttle, a space probe, a space station, a lunar lander, a rover, an orbital capsule, an interplanetary probe, etc.

FIG. 2 illustrates a plurality of farms comprising the first farm 202, a second farm 204 and/or a third farm 206, in accordance with some embodiments. The first farm 202 may comprise one or more resources (comprising the first resource 212) that are the first type of resource. The first farm 202 may comprise one or more resources (comprising a second resource 210) that are a second type of resource (e.g., an airplane and/or an airplane of a defined type, make, year and/or model). The first farm 202 may comprise one or more resources that are a third type of resource (e.g., a truck and/or a truck of a defined type, make, year and/or model). The second farm 204 may comprise one or more resources (e.g., cars) that are the first type of resource and/or one or more resources (e.g., trucks) that are the third type of resource. The third farm 206 may comprise one or more resources (e.g., cars) that are the first type of resource and/or one or more resources (e.g., airplanes) that are the second type of resource.

At 104 of FIG. 1, a first token 306 for the first type of resource and/or the first resource 212 may be generated. In some examples, the first token 306 comprises a first utility token, a first security token, a first payment token, a first Non-Fungible Token (NFT), a first stable Coin, a first bearer token, a first refresh token, a first ID token, a first JSON web token (JWT), a first connected token, and/or a first disconnected token. In some examples, the first token 306 may comprise a single token. Embodiments are contemplated in which the first token 306 comprises a plurality of tokens.

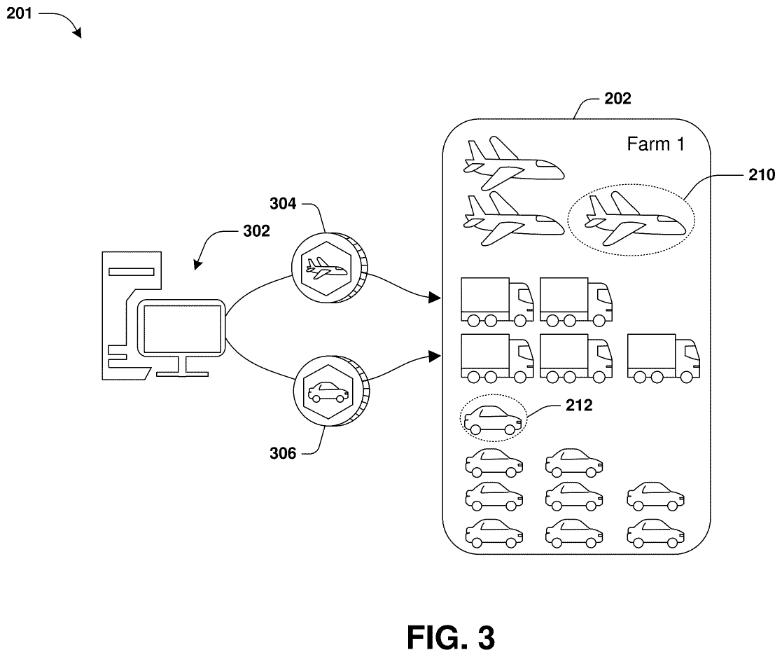

In some examples, the first token 306 may be generated using a token issuer module and/or a client device 302 (shown in FIG. 3) associated with the first farm 202. The token issuer module may be configured to certify transactions and/or data associated with tokenization and/or records. In some examples, the client device 302 associated with the first farm 202 (e.g., the client device 302 may comprise a requesting client of the first farm 202) may transmit, to the token issuer module, a tokenization request comprising data indicative of the first type of resource and/or the first resource 212. In some examples, the token issuer module may validate and/or certify (e.g., cryptographically certify) the tokenization request in response to receiving the tokenization request. The tokenization request may be validated and/or certified based upon a determination that the tokenization request follows one or more rules associated with an ecosystem (of which the first farm 202 is a part, for example). In some examples, the token issuer module may generate a certification (e.g., a certificate and/or a cryptographic signature) in response to validating and/or certifying the tokenization request. In some examples, a transaction data structure may be generated (by the client device 302 and/or the token issuer module, for example) to comprise the tokenization request, the certification, a target smart contract address indicative of a target smart contract (e.g., a token contract), and/or a key (e.g., a private key) associated with the first farm 202.

The client device 302 and/or the token issuer module may broadcast the transaction data structure into a blockchain network, such as by transmitting the transaction data structure (over the Internet, for example) to a blockchain node of the blockchain network. In some examples, the target smart contract (and/or one or more nodes of the blockchain network that run a smart contract program of the target smart contract) may generate the first token 306, for example, in response to validating the transaction data structure (e.g., the transaction data structure may be validated based upon a determination that the certification and/or the tokenization request are valid and/or satisfy one or more conditions, such as one or more conditions indicated by the target smart contract).

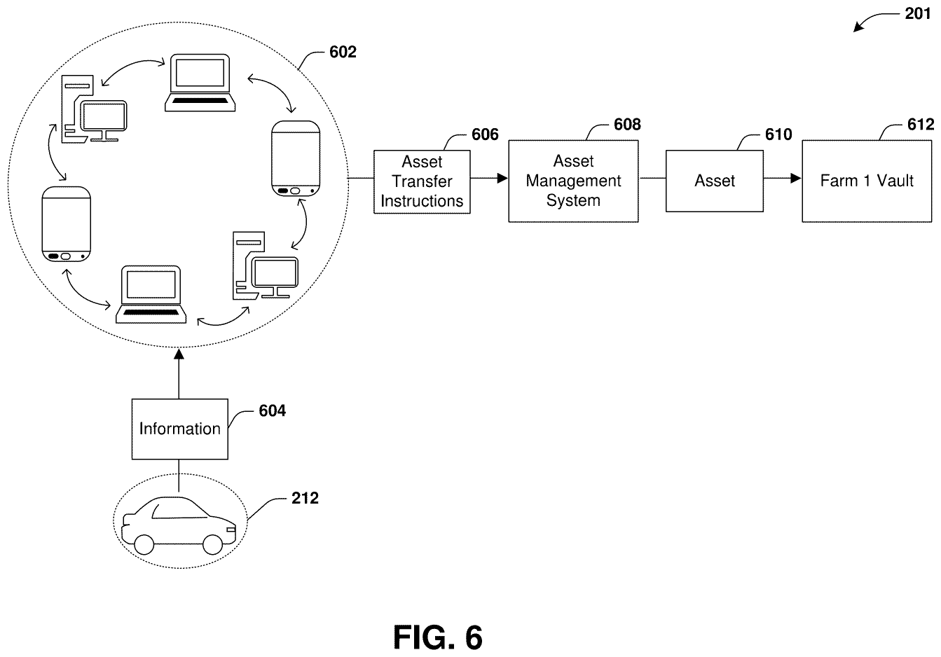

At 106 of FIG. 1, the first token 306 (for the first type of resource and/or the first resource 212) may be allocated to the first farm 202. In some examples, the first token 306 may be allocated (by the target smart contract and/or one or more nodes of the blockchain network that run the smart contract program of the target smart contract, for example) to the first farm 202 in response to generating the first token 306. The first token 306 may be allocated to the first farm 202 based upon the first farm 202 having the first resource 212 (which is the first type of resource to which the first token 306 is allocated, for example). In some examples, allocating (e.g., crediting and/or assigning) the first token 306 to the first farm 202 comprises setting an owner field of the first token 306 to be indicative of the first farm 202 and/or a vault address (e.g., wallet address) associated with a vault 612 (shown in FIG. 6) of the first farm 202, which may record, in a blockchain ledger of the blockchain network, ownership by the first farm 202 of the first token 306.

FIG. 3 illustrates allocation of the first token 306 and/or a second token 304 for the second type of resource and/or the second resource 210 to the first farm 202, in accordance with some embodiments. The second token 304 may be generated and/or allocated to the first farm 202 (by the client device 302 and/or the token issuer module, for example) using one or more of the techniques provided herein with respect to generating the first token 306 and/or allocating the first token 306 to the first farm 202.

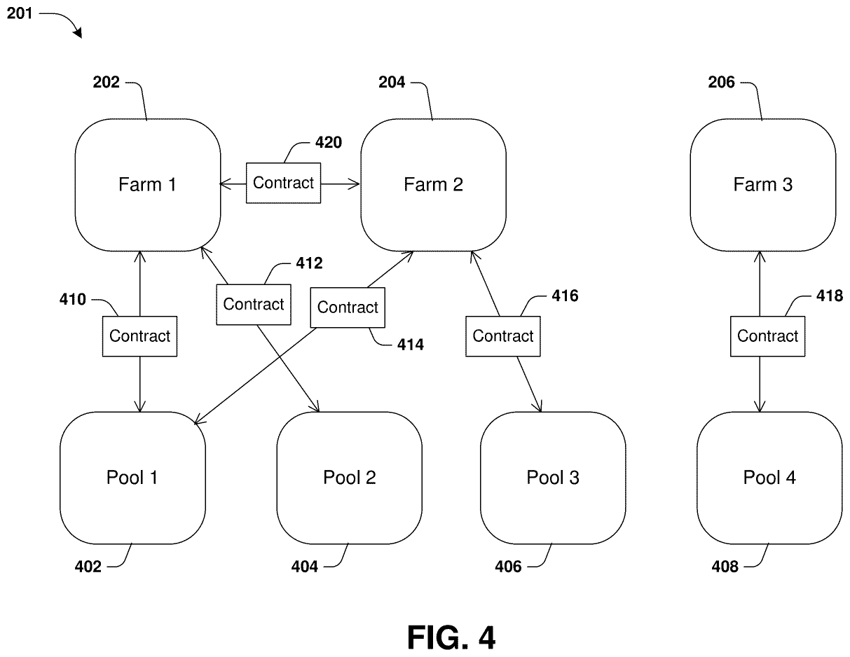

At 108 of FIG. 1, a first contract 410 (shown in FIG. 4) between the first farm 202 and a first pool 402 may be determined. In some examples, the first contract 410 may comprise a first smart contract. The first contract 410 may comprise a first smart contract program (e.g., program code) and/or data indicative of rules for transactions, asset allocations, and/or participation records. The first contract 410 may be stored in one, some, or all nodes of the blockchain network. The first contract 410 may be deployed (by the first pool 402, for example) by transmitting a deployment transaction to the blockchain network. Nodes of the blockchain network may execute and/or validate the deployment transaction. In response to executing and/or validating the deployment transaction, the first smart contract (and/or the first smart contract program) and/or one or more variables (e.g., initial state variables) associated with the first smart contract may be written into the blockchain ledger. In some examples, one, some, or all nodes of the blockchain network may store the first smart contract in a local copy of the blockchain ledger.

In some examples, the first farm 202 joins the first contract 410 (after the first contract 410 is deployed by the first pool 402, for example). For example, the first farm 202 may join the first contract 410 (and/or may join the first pool 402) using the client device 302 associated with the first farm 202. The client device 302 may determine a smart contract address of the first contract 410 (which may correspond to a pool contract address of the first pool 402). The client device 302 may generate a first blockchain transaction for joining the first contract 410. The first blockchain transaction may be indicative of one or more tokenized assets, such as the first token 306 associated with the first type of resource, the second token 304 associated with the second type of resource, and/or one or more other tokens (owned by and/or allocated to the first farm 202, for example). The first blockchain transaction may comprise the key (e.g., the private key) associated with the first farm 202 (e.g., the first blockchain transaction may be signed with the key). The client device 302 may transmit the first blockchain transaction to the blockchain network, which may propagate the first blockchain transaction to one, some, or all nodes of the blockchain network. The first contract 410 may record the first farm 202 as a participant of the first contract 410 in response to at least one of signature, issuer certification, farm eligibility, asset ownership, etc. of the first blockchain transaction being verified by one or more nodes of the blockchain network. In some examples, the executed first blockchain transaction may be recorded in the blockchain ledger. In some examples, the client device 302 (and/or other entity) may query the blockchain ledger to identify the first contract 410 between the first farm 202 and the first pool 402 (and/or to confirm that the first farm 202 is a participant of the first contract 410). In some examples, the one or more tokenized assets (e.g., at least one of the first token 306, the second token 304, etc.) may be registered and/or locked to the first contract 410 and/or the first pool 402.

FIG. 4 illustrates a plurality of contracts associated with the plurality of farms and a plurality of pools in the ecosystem, in accordance with some embodiments. The plurality of pools may comprise the first pool 402, a second pool 404, a third pool 406, and/or a fourth pool 408. In some examples, each pool of one, some, or all of the plurality of pools may comprise one or more load matching model for allocating resources (e.g., vehicles and/or other types of resources) to service requests. The plurality of contracts may comprise the first contract 410 between the first farm 202 and the first pool 402, a second contract 412 between the first farm 202 and the second pool 404, a third contract 414 between the second farm 204 and the first pool 402, a fourth contract 416 between the second farm 204 and the third pool 406, a fifth contract 420 between the first farm 202 and the second farm 204, and/or a contract 418 (e.g., a smart contract) between the third farm 206 and the fourth pool 408. In some examples, a contract of the plurality of contracts may be indicative of a load matching model used by a pool of the plurality of pools.

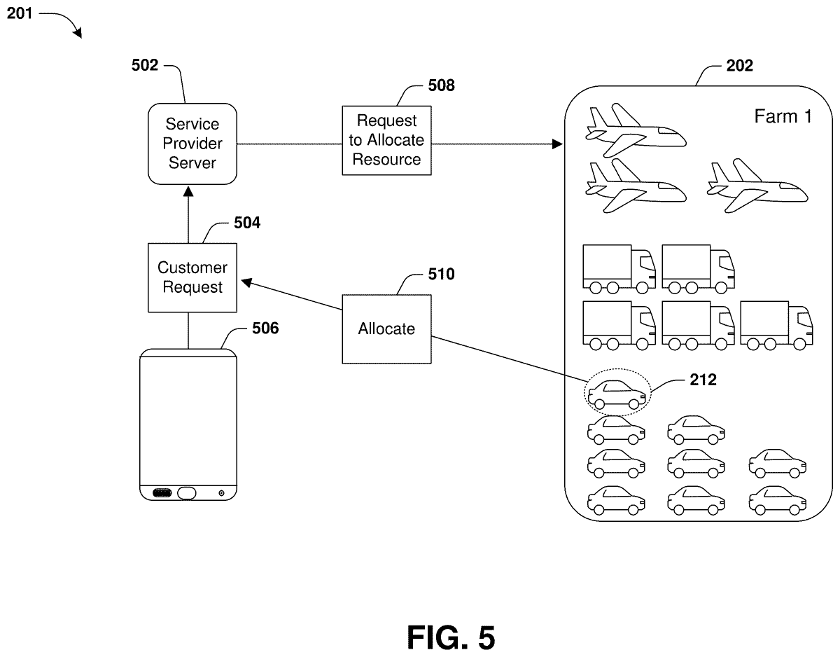

At 110 of FIG. 1, responsive to a first customer request 504 (shown in FIG. 5) associated with a first service performable by the first type of resource, the first resource 212 may be allocated to the first customer request 504. In some examples, the first resource 212 may be allocated to the first customer request 504 based upon determining (in response to the first customer request 504, for example) that the first pool 402 has the first contract 410 with the first farm 202, that the first farm 202 has the first resource 212 that is the first type of resource, and/or that the first resource 212 (and/or the first type of resource) is usable to perform the first service requested by the first customer request 504.

FIG. 5 illustrates reception of the first customer request 504 by a service provider server 502 associated with a service provider of the first service, in accordance with some embodiments. The service provider of the first service may correspond to the first pool 402 (e.g., the first service may be provided by the first pool 402). The first customer request 504 may be transmitted by a customer device 506 (e.g., at least one of a phone, a smartphone, a wearable device, a laptop, a tablet, a computer, etc.) associated with a first customer to the service provider server 502. The first customer request 504 may be indicative of the first service, customer information associated with the first customer, and/or other information.

In some examples, in response to receiving the first customer request 504, the service provider server 502 may determine that the first pool 402 has the first contract 410 with the first farm 202 (by querying the blockchain ledger to identify the first contract 410 between the first farm 202 and the first pool 402, for example), determine that the first farm 202 has the first resource 212 that is the first type of resource, determine that the first resource 212 (and/or the first type of resource) is usable to perform the first service requested by the first customer request 504, and/or transmit an allocation request 508 to the first farm 202 (and/or to the client device 302 associated with the first farm 202) requesting to allocate the first resource 212 to the first customer request 504. In some examples, in response to receiving the allocation request 508, the first resource 212 may be allocated to the first customer request 504.

In some examples, one or more first allocation operations 510 may be performed to allocate the first resource 212 to the first customer request 504. In some examples, the one or more first allocation operations 510 may comprise transmitting (by the service provider server 502 and/or the client device 302 of the first farm 202, for example) an indication of the allocation of the first resource 212 to the first customer request 504 to the blockchain network. In some examples, the one or more first allocation operations 510 may comprise recording (by the service provider server 502, the client device 302, and/or the first contract 410, for example) the allocation of the first resource 212 to the first customer request 504 in the blockchain ledger. In some examples, the first resource 212 comprises a programmable device. The one or more first allocation operations 510 may comprise generating one or more commands for performing the first service and/or transmitting the one or more commands to the programmable device.

In some examples, in response to allocating the first resource 212 to the first customer request 504, the first resource 212 may be used to perform and/or facilitate the first service. In an exemplary scenario, the first service may comprise a car rental service and/or the first resource 212 may comprise a car rented to the customer for a duration of time. Other examples of the first service are within the scope of the present disclosure.

At 112 of FIG. 1, a first decentralized consensus mechanism 602 (shown in FIG. 6) may be used to determine a first value associated with fulfillment of the first customer request 504 via performance of the first service by the first resource 212. In some examples, the first decentralized consensus mechanism 602 may comprise a network of nodes (e.g., one or more types of computers). The first value may correspond to a pool income, a market capital, and/or a generated revenue associated with use of the first resource 212 to perform the first service. In some examples, the first decentralized consensus mechanism 602 may evaluate performance of the first service to determine the first value.

The first decentralized consensus mechanism 602 may evaluate performance of the first service and/or determine the first value based upon information 604 (shown in FIG. 6) associated with the first resource 212 and/or the first service. The information 604 (based upon which the first decentralized consensus mechanism 602 determines the first value) may comprise one or more resource contribution and/or usage metrics associated with use of the first resource 212 to perform the first service, availability status associated with the first resource 212 (e.g., whether the first resource 212 is reserved or on-call), environmental conditions associated with the first service, risk management, insurance coverage, one or more customer satisfaction metrics, and/or other information. In some examples, the information 604 may be provided to the first decentralized consensus mechanism 602 by the first resource 212 (e.g., by the programmable device of the first resource 212), the first farm 202, the first pool 402, and/or other entity.

In some examples, the first decentralized consensus mechanism 602 may use a first proof of work (PoW) model to determine the first value. In some examples, the first decentralized consensus mechanism 602 may determine the first PoW model based upon (and/or may retrieve the first PoW model from) the first contract 410 (e.g., the first contract 410 may be indicative of the first PoW model). In some examples, the first PoW model may be executed by the first decentralized consensus mechanism 602 to measure an amount that the first resource 212 contributes to revenue and/or common value of the first pool 402. In some examples, the first decentralized consensus mechanism 602 may determine a revenue share and/or PoW share associated with the first resource 212 and/or the first pool 402 by executing the first PoW model based upon the information 604. In some examples, the revenue share may correspond to a proportion of revenue associated with (and/or derived from) the first resource 212 relative to total revenue associated with the first pool 402. In some examples, the PoW share may correspond to a proportion of PoW associated with the first resource 212 relative to total PoW associated with the first pool 402. In some examples, the revenue share and/or the PoW share may be used to determine the first value.

In some examples, the first PoW model may be configured based upon one or more first parameters including a first risk determination function related to the first type of resource (and/or the first resource 212), one or more first time-related coefficients related to the first type of resource (and/or the first resource 212), a first activity time function related to the first type of resource (and/or the first resource 212), a first correlation and integration function of a time available related to the first type of resource (and/or the first resource 212), a first income function related to the first type of resource (and/or the first resource 212), and/or a first customer satisfaction parameter related to the first type of resource (and/or the first resource 212).

In some examples, the first value may be determined according to

$$Pow ( V ) = \frac{R ( V )}{R ( P )} ( α \frac{T ( V )}{T ( P )} Inter ( V ) + β \frac{I ( V )}{I ( P )} \times \frac{S ( V )}{S ( P )} ) ,$$

where V corresponds to the first type of resource, P corresponds to the first pool 402, Pow(V) corresponds to the first value associated with the first resource 212 determined according to the first PoW model, R( ) corresponds to the first risk determination function (which may be based upon one or more factors such as one or more environmental factors and/or one or more other factors), a corresponds to a time-related coefficient of the one or more first time-related coefficients, T( ) corresponds to the first activity time function, Inter( ) corresponds to the first correlation and integration function of the time available, I( ) corresponds to the first income function (of a relevant domain, for example), and/or S( ) corresponds to the first customer satisfaction parameter.

At 114 of FIG. 1, a first transfer of a first asset 610 (shown in FIG. 6) to the first farm 202 may be executed based upon the first value (determined by the first decentralized consensus mechanism 602, for example). In some examples, executing the first transfer of the first asset 610 includes executing a first token payment, executing a first digital coin payment, executing a first Non-Fungible Token (NFT) payment, transferring a first real-world asset, transferring a first stock share, and/or executing a first Fiat payment.

FIG. 6 illustrates use of the first decentralized consensus mechanism 602 to execute the first transfer of the first asset 610 to the first farm 202, in accordance with some embodiments. In some examples, the first decentralized consensus mechanism 602 may provide asset transfer instructions 606 indicative of the first value to an asset management system 608. In some examples, the asset management system 608 may comprise a banking system, a digital wallet platform, a stored-value platform, a payment service, a cryptocurrency exchange, a cryptocurrency wallet platform, a decentralized finance platform, an investment and/or brokerage system, a corporate treasury system, a cash management system, a central bank digital currency account, a loyalty management system, a commodity platform, and/or a real estate tokenization platform.

In some examples, the asset management system 608 may transfer the first asset 610 to the vault 612 associated with the first farm 202. In some examples, the vault 612 may comprise a digital wallet, a bank account, a crypto wallet, a physical vault, a virtual vault, a payment account, a stored-value account, an E-money account, a P2P payment account, and/or other type of account and/or wallet. In some examples, the first asset 610 may comprise a token, a digital coin, an NFT, a real-world asset, a stock share, rewards and/or loyalty points, credit, and/or Fiat. In some examples, an amount of the first asset 610 may be based upon (and/or may be equal and/or equivalent to) the first value (indicated by the asset transfer instructions 606, for example).

In some examples, a request to allocate a first defined portion of the first resource 212 to the first farm 202 may be received from an owner of the first resource 212. In an exemplary scenario in which the first resource 212 comprises computer memory, the first defined portion (e.g., 30%) may correspond to a portion of the computer memory (e.g., 30 gigabytes of 100 gigabytes of computer memory). In an exemplary scenario in which the first resource 212 comprises an apartment building, the first defined portion may correspond to one or more rooms of the apartment building. In an exemplary scenario in which the first resource 212 comprises an apartment unit, the first defined portion may correspond to one or more rooms of the apartment unit. In some examples, the first value (indicated by the asset transfer instructions 606, for example) may be determined based upon the first defined portion (of the first resource 212) that is allocated to the first farm 202.

In some examples, a request to allocate a second defined portion of the first resource 212 to a different farm may be received from the owner of the first resource 212. In some examples, the first decentralized consensus mechanism 602 (and/or a different decentralized consensus mechanism) may be used to determine a value for the different farm based upon the second defined portion (of the first resource 212) that is allocated to the different farm, such as using one or more of the techniques provided herein with respect to determining the first value (indicated by the asset transfer instructions 606, for example). In some examples, a transfer to the different farm may be executed based upon the value, such as by executing a token payment, executing a digital coin payment, executing an NFT payment, transferring a real-world asset, transferring a stock share, and/or executing a Fiat payment.

In some examples, the first decentralized consensus mechanism 602 (and/or a different decentralized consensus mechanism) may determine a first reward for the first customer associated with the first customer request 504. For example, the first reward may be determined based upon an income and/or revenue generated by the first service and/or one or more other services associated with the first customer request 504. In some examples, a transfer to the first customer may be executed based upon the first reward, such as by executing a token payment, executing a digital coin payment, executing an NFT payment, transferring a real-world asset, transferring a stock share, and/or executing a Fiat payment.

In some examples, a first expected revenue for the first resource 212 in association with the first pool 402 may be determined and/or presented to the first farm 202 (by displaying the first expected revenue on the client device 302, for example). For example, the first expected revenue for the first resource 212 in association with the first pool 402 may be determined and/or presented to the first farm 202 prior to the first farm 202 joining the first contract 410. In some examples, the first expected revenue may be determined based upon historical transfers of assets associated with the first pool 402 (and/or other pools that provide one or more services related to and/or matching one or more services provided by the first pool 402) and/or other information. The historical transfers of assets may be determined using (and/or may be indicated by) the blockchain ledger.

In some examples, the second resource 210 (shown in FIG. 2) associated with the first farm 202 may be determined. The second resource 210 may be the second type of resource (e.g., an airplane and/or an airplane of a defined type, make, year and/or model). The second token 304 (shown in FIG. 3) for the second type of resource and/or the second resource 210 may be generated, such as using one or more of the techniques provided herein with respect to generating the first token 306. In some examples, the second token 304 comprises a utility token, a security token, a payment token, an NFT, a stable Coin, a bearer token, a refresh token, an ID token, a JWT, a connected token, and/or a disconnected token.

The second token 304 (for the second type of resource and/or the second resource 210) may be allocated to the first farm 202. In some examples, the second token 304 may be allocated (by a target smart contract and/or one or more nodes of the blockchain network that run a smart contract program of the target smart contract, for example) to the first farm 202 in response to generating the second token 304. The second token 304 may be allocated to the first farm 202 based upon the first farm 202 having the second resource 210 (which is the second type of resource to which the second token 304 is allocated, for example). In some examples, allocating (e.g., crediting and/or assigning) the second token 304 to the first farm 202 comprises setting an owner field of the second token 304 to be indicative of the first farm 202 and/or the vault address (e.g., wallet address) associated with the vault 612 of the first farm 202, which may record, in the blockchain ledger of the blockchain network, ownership by the first farm 202 of the second token 304.

In some examples, responsive to the first customer request 504 (shown in FIG. 5) being associated with a second service performable by the second type of resource (in addition to the first customer request 504 being associated with the first service performable by the first type of resource, for example), the second resource 210 may be allocated to the first customer request 504. In some examples, the second resource 210 may be allocated to the first customer request 504 based upon determining (in response to the first customer request 504, for example) that the first pool 402 has the first contract 410 with the first farm 202, that the first farm 202 has the second resource 210 that is the second type of resource, and/or that the second resource 210 (and/or the second type of resource) is usable to perform the second service requested by the first customer request 504. The service provider of the first service may provide the second service (in addition to providing the first service, for example). The first customer request 504 may be indicative of the second service.

In some examples, in response to receiving the first customer request 504, the service provider server 502 may determine that the first pool 402 has the first contract 410 with the first farm 202 (by querying the blockchain ledger to identify the first contract 410 between the first farm 202 and the first pool 402, for example), determine that the first farm 202 has the second resource 210 that is the second type of resource, determine that the second resource 210 (and/or the second type of resource) is usable to perform the second service requested by the first customer request 504, and/or transmit the allocation request 508 to the first farm 202 (and/or to the client device 302 associated with the first farm 202) which may request to allocate the second resource 210 to the first customer request 504. In some examples, in response to receiving the allocation request 508, the second resource 210 may be allocated to the first customer request 504.

In some examples, one or more allocation operations may be performed to allocate the second resource 210 to the first customer request 504. In some examples, the one or more allocation operations may comprise transmitting (by the service provider server 502 and/or the client device 302 of the first farm 202, for example) an indication of the allocation of the second resource 210 to the first customer request 504 to the blockchain network. In some examples, the one or more allocation operations may comprise recording (by the service provider server 502, the client device 302, and/or the first contract 410, for example) the allocation of the second resource 210 to the first customer request 504 in the blockchain ledger. In some examples, the second resource 210 comprises a programmable device. The one or more allocation operations may comprise generating one or more commands for performing the second service and/or transmitting the one or more commands to the programmable device of the second resource 210.

In some examples, in response to allocating the second resource 210 to the first customer request 504, the second resource 210 may be used to perform and/or facilitate the second service. In an exemplary scenario, the second service may comprise an air transportation service and/or the second resource 210 may comprise an airplane used by the customer for one or more flights.

The first decentralized consensus mechanism 602 (shown in FIG. 6) may be used to determine a second value associated with fulfillment of the first customer request 504 via performance of the second service by the second resource 210. The second value may correspond to a pool income, a market capital, and/or a generated revenue associated with use of the second resource 210 to perform the second service. In some examples, the first decentralized consensus mechanism 602 may evaluate performance of the second service to determine the second value.

The first decentralized consensus mechanism 602 may evaluate performance of the second service and/or determine the second value based upon a set of information associated with the second resource 210 and/or the second service. The set of information (based upon which the first decentralized consensus mechanism 602 determines the second value) may comprise one or more resource contribution and/or usage metrics associated with use of the second resource 210 to perform the second service, availability status associated with the second resource 210 (e.g., whether the second resource 210 is reserved or on-call), environmental conditions associated with the second service, risk management, insurance coverage, one or more customer satisfaction metrics, and/or other information. In some examples, the set of information may be provided to the first decentralized consensus mechanism 602 by the second resource 210 (e.g., by the programmable device of the second resource 210), the first farm 202, the first pool 402, and/or other entity. In some examples, the first decentralized consensus mechanism 602 may use the first PoW model to determine the second value, such as using one or more of the techniques provided herein with respect to using the first PoW model to determine the first value. Embodiments are contemplated in which the second value is determined using a different decentralized consensus mechanism (different than the first decentralized consensus mechanism 602) and/or a different PoW model (different than the first PoW model).

In some examples, a second transfer of a second asset to the first farm 202 may be executed based upon the second value (determined by the first decentralized consensus mechanism 602, for example). In some examples, executing the second transfer of the second asset includes executing a token payment, executing a digital coin payment, executing an NFT payment, transferring a real-world asset, transferring a stock share, and/or executing a Fiat payment.

In some examples, the first decentralized consensus mechanism 602 may provide asset transfer instructions (e.g., the asset transfer instructions 606 shown in FIG. 6) indicative of the second value to the asset management system 608. In some examples, the asset management system 608 may transfer the second asset to the vault 612 associated with the first farm 202. In some examples, the second asset may comprise a token, a digital coin, an NFT, a real-world asset, a stock share, rewards and/or loyalty points, credit, and/or Fiat. In some examples, an amount of the second asset may be based upon (and/or may be equal and/or equivalent to) the second value.

The second contract 412 (shown in FIG. 4) between the first farm 202 and the second pool 404 may be determined. In some examples, the second contract 412 may comprise a second smart contract. The second contract 412 may comprise a second smart contract program (e.g., program code) and/or data indicative of rules for transactions, asset allocations, and/or participation records. The second contract 412 may be stored in one, some, or all nodes of the blockchain network. The second contract 412 may be deployed (by the second pool 404, for example) by transmitting a deployment transaction to the blockchain network. Nodes of the blockchain network may execute and/or validate the deployment transaction. In response to executing and/or validating the deployment transaction, the second smart contract (and/or the second smart contract program) and/or one or more variables (e.g., initial state variables) associated with the second smart contract may be written into the blockchain ledger. In some examples, one, some, or all nodes of the blockchain network may store the second smart contract in a local copy of the blockchain ledger.

In some examples, the first farm 202 joins the second contract 412 (after the second contract 412 is deployed by the second pool 404, for example). For example, the first farm 202 may join the second contract 412 (and/or may join the second pool 404) using the client device 302 associated with the first farm 202. The client device 302 may determine a smart contract address of the second contract 412 (which may correspond to a pool contract address of the second pool 404). The client device 302 may generate a second blockchain transaction for joining the second contract 412. The second blockchain transaction may be indicative of one or more tokenized assets, such as the first token 306 associated with the first type of resource, the second token 304 associated with the second type of resource, and/or one or more other tokens (owned by and/or allocated to the first farm 202, for example). The second blockchain transaction may comprise the key (e.g., the private key) associated with the first farm 202 (e.g., the second blockchain transaction may be signed with the key). The client device 302 may transmit the second blockchain transaction to the blockchain network, which may propagate the second blockchain transaction to one, some, or all nodes of the blockchain network. The second contract 412 may record the first farm 202 as a participant of the second contract 412 in response to at least one of signature, issuer certification, farm eligibility, asset ownership, etc. of the second blockchain transaction being verified by one or more nodes of the blockchain network. In some examples, the executed second blockchain transaction may be recorded in the blockchain ledger. In some examples, the client device 302 (and/or other entity) may query the blockchain ledger to identify the second contract 412 between the first farm 202 and the second pool 404 (and/or to confirm that the first farm 202 is a participant of the second contract 412). In some examples, the one or more tokenized assets (e.g., at least one of the first token 306, the second token 304, etc.) may be registered and/or locked to the second contract 412 and/or the second pool 404.

In some examples, responsive to a second customer request associated with a third service performable by the first type of resource, the first resource 212 may be allocated to the second customer request. In some examples, the first resource 212 may be allocated to the second customer request based upon determining (in response to the second customer request, for example) that the second pool 404 has the second contract 412 with the first farm 202, that the first farm 202 has the first resource 212 that is the first type of resource, and/or that the first resource 212 (and/or the first type of resource) is usable to perform the third service requested by the second customer request. In some examples, the second pool 404 may correspond to a service provider of the third service. The second customer request may be indicative of the third service.

In some examples, the second customer request may be received by a server associated with the second pool 404. In response to receiving the second customer request, the second pool 404 and/or the server may determine that the second pool 404 has the second contract 412 with the first farm 202 (by querying the blockchain ledger to identify the second contract 412 between the first farm 202 and the second pool 404, for example), determine that the first farm 202 has the first resource 212 that is the first type of resource, determine that the first resource 212 (and/or the first type of resource) is usable to perform the third service requested by the second customer request, and/or transmit a second allocation request to the first farm 202 (and/or to the client device 302 associated with the first farm 202) which may request to allocate the first resource 212 to the second customer request. In some examples, in response to receiving the second allocation request, the first resource 212 may be allocated to the second customer request.

In some examples, one or more allocation operations may be performed to allocate the first resource 212 to the second customer request. In some examples, the one or more allocation operations may comprise transmitting (by the second pool 404, the server associated with the second pool 404, and/or the client device 302 of the first farm 202, for example) an indication of the allocation of the first resource 212 to the second customer request to the blockchain network. In some examples, the one or more allocation operations may comprise recording (by the second pool 404, the server associated with the second pool 404, the client device 302, and/or the second contract 412, for example) the allocation of the first resource 212 to the second customer request in the blockchain ledger. In some examples, the first resource 212 comprises a programmable device. The one or more allocation operations may comprise generating one or more commands for performing the third service and/or transmitting the one or more commands to the programmable device of the first resource 212.

In some examples, in response to allocating the first resource 212 to the second customer request, the first resource 212 may be used to perform and/or facilitate the third service. In an exemplary scenario, the third service may comprise a car rental service and/or the first resource 212 may comprise a car rented to the customer for a duration of time. Other examples of the third service are within the scope of the present disclosure.

A second decentralized consensus mechanism may be used to determine a third value associated with fulfillment of the second customer request via performance of the third service by the first resource 212. In some examples, the second decentralized consensus mechanism may comprise a network of nodes (e.g., one or more types of computers). The third value may correspond to a pool income, a market capital, and/or a generated revenue associated with use of the first resource 212 to perform the third service. In some examples, the second decentralized consensus mechanism may evaluate performance of the third service to determine the third value.

The second decentralized consensus mechanism may evaluate performance of the third service and/or determine the third value based upon a set of information associated with the first resource 212 and/or the third service. The set of information (based upon which the second decentralized consensus mechanism determines the third value) may comprise one or more resource contribution and/or usage metrics associated with use of the first resource 212 to perform the third service, availability status associated with the first resource 212 (e.g., whether the first resource 212 is reserved or on-call), environmental conditions associated with the third service, risk management, insurance coverage, one or more customer satisfaction metrics, and/or other information. In some examples, the set of information may be provided to the second decentralized consensus mechanism by the first resource 212 (e.g., by the programmable device of the first resource 212), the first farm 202, the second pool 404, and/or other entity.

In some examples, the second decentralized consensus mechanism may use a second PoW model to determine the third value. In some examples, the second decentralized consensus mechanism may determine the second PoW model based upon (and/or may retrieve the second PoW model from) the second contract 412 (e.g., the second contract 412 may be indicative of the second PoW model). In some examples, the second PoW model may be executed by the second decentralized consensus mechanism to measure an amount that the first resource 212 contributes to revenue and/or common value of the second pool 404. In some examples, the second decentralized consensus mechanism may determine a revenue share and/or PoW share associated with the first resource 212 and/or the second pool 404 by executing the second PoW model based upon the set of information associated with the first resource 212 and/or the third service. In some examples, the revenue share may correspond to a proportion of revenue associated with (and/or derived from) the first resource 212 relative to total revenue associated with the second pool 404. In some examples, the PoW share may correspond to a proportion of PoW associated with the first resource 212 relative to total PoW associated with the second pool 404. In some examples, the revenue share and/or the PoW share may be used to determine the third value.

In some examples, the second PoW model may be configured based upon one or more second parameters including a second risk determination function related to the first type of resource (and/or the first resource 212), one or more second time-related coefficients related to the first type of resource (and/or the first resource 212), a second activity time function related to the first type of resource (and/or the first resource 212), a second correlation and integration function of a time available related to the first type of resource (and/or the first resource 212), a second income function related to the first type of resource (and/or the first resource 212), and/or a second customer satisfaction parameter related to the first type of resource (and/or the first resource 212).

In some examples, the third value may be determined according to

$$Pow ( V ) = \frac{R ( V )}{R ( P )} ( α \frac{T ( V )}{T ( P )} Inter ( V ) + β \frac{I ( V )}{I ( P )} \times \frac{S ( V )}{S ( P )} ) ,$$

where V corresponds to the first type of resource, P corresponds to the second pool 404, Pow(V) corresponds to the third value associated with the first resource 212 determined according to the second PoW model, R( ) corresponds to the second risk determination function (which may be based upon one or more factors such as one or more environmental factors and/or one or more other factors), a corresponds to a time-related coefficient of the one or more second time-related coefficients, T( ) corresponds to the second activity time function, Inter( ) corresponds to the second correlation and integration function of the time available, I( ) corresponds to the second income function (of a relevant domain, for example), and/or S( ) corresponds to the second customer satisfaction parameter. Embodiments are contemplated in which the third value is determined using the first decentralized consensus mechanism 602 and/or the first PoW model.

In some examples, a third transfer of a third asset to the first farm 202 may be executed based upon the third value (determined by the second decentralized consensus mechanism, for example). In some examples, executing the third transfer of the third asset includes executing a token payment, executing a digital coin payment, executing an NFT payment, transferring a real-world asset, transferring a stock share, and/or executing a Fiat payment.

In some examples, the second decentralized consensus mechanism may provide asset transfer instructions indicative of the third value to the asset management system 608. In some examples, the asset management system 608 may transfer the third asset to the vault 612 associated with the first farm 202. In some examples, the third asset may comprise a token, a digital coin, an NFT, a real-world asset, a stock share, rewards and/or loyalty points, credit, and/or Fiat. In some examples, an amount of the third asset may be based upon (and/or may be equal and/or equivalent to) the third value.

In some examples, a third resource 214 (shown in FIG. 2) associated with the second farm 204 may be determined. The third resource 214 may be the third type of resource (e.g., a truck and/or a truck of a defined type, make, year and/or model). A third token for the third type of resource and/or the third resource 214 may be generated, such as using one or more of the techniques provided herein with respect to generating the first token 306. In some examples, the third token comprises a utility token, a security token, a payment token, an NFT, a stable Coin, a bearer token, a refresh token, an ID token, a JWT, a connected token, and/or a disconnected token.

The third token (for the third type of resource and/or the third resource 214) may be allocated to the second farm 204. In some examples, the third token may be allocated (by a target smart contract and/or one or more nodes of the blockchain network that run a smart contract program of the target smart contract, for example) to the second farm 204 in response to generating the third token. The third token may be allocated to the second farm 204 based upon the second farm 204 having the third resource 214 (which is the third type of resource to which the third token is allocated, for example). In some examples, allocating (e.g., crediting and/or assigning) the third token to the second farm 204 comprises setting an owner field of the third token to be indicative of the second farm 204 and/or a vault address (e.g., wallet address) associated with a second vault of the second farm 204, which may record, in the blockchain ledger of the blockchain network, ownership by the second farm 204 of the third token.

The third contract 414 (shown in FIG. 4) between the second farm 204 and the first pool 402 may be determined. In some examples, the third contract 414 may comprise a third smart contract. The third contract 414 may comprise a third smart contract program (e.g., program code) and/or data indicative of rules for transactions, asset allocations, and/or participation records. The third contract 414 may be stored in one, some, or all nodes of the blockchain network. The third contract 414 may be deployed (by the first pool 402, for example) by transmitting a deployment transaction to the blockchain network. Nodes of the blockchain network may execute and/or validate the deployment transaction. In response to executing and/or validating the deployment transaction, the third smart contract (and/or the third smart contract program) and/or one or more variables (e.g., initial state variables) associated with the third smart contract may be written into the blockchain ledger. In some examples, one, some, or all nodes of the blockchain network may store the third smart contract in a local copy of the blockchain ledger.

In some examples, the second farm 204 joins the third contract 414 (after the third contract 414 is deployed by the first pool 402, for example). For example, the second farm 204 may join the third contract 414 (and/or may join the first pool 402) using a client device associated with the second farm 204. The client device may determine a smart contract address of the third contract 414 (which may correspond to a pool contract address of the first pool 402). The client device may generate a third blockchain transaction for joining the third contract 414. The third blockchain transaction may be indicative of one or more tokenized assets, such as the third token associated with the third type of resource and/or one or more other tokens (owned by and/or allocated to the second farm 204, for example). The third blockchain transaction may comprise a second key (e.g., a private key) associated with the second farm 204 (e.g., the third blockchain transaction may be signed with the second key). The client device may transmit the third blockchain transaction to the blockchain network, which may propagate the third blockchain transaction to one, some, or all nodes of the blockchain network. The third contract 414 may record the second farm 204 as a participant of the third contract 414 in response to at least one of signature, issuer certification, farm eligibility, asset ownership, etc. of the third blockchain transaction being verified by one or more nodes of the blockchain network. In some examples, the executed third blockchain transaction may be recorded in the blockchain ledger. In some examples, the client device (and/or other entity) may query the blockchain ledger to identify the third contract 414 between the second farm 204 and the first pool 402 (and/or to confirm that the second farm 204 is a participant of the third contract 414). In some examples, the one or more tokenized assets (e.g., the third token, etc.) may be registered and/or locked to the third contract 414 and/or the first pool 402.

In some examples, responsive to a third customer request associated with a fourth service performable by the third type of resource, the third resource 214 may be allocated to the third customer request. In some examples, the third resource 214 may be allocated to the third customer request based upon determining (in response to the third customer request, for example) that the first pool 402 has the third contract 414 with the second farm 204, that the second farm 204 has the third resource 214 that is the third type of resource, and/or that the third resource 214 (and/or the third type of resource) is usable to perform the fourth service requested by the third customer request. In some examples, the first pool 402 may correspond to a service provider of the fourth service. The third customer request may be indicative of the fourth service.

In some examples, the third customer request may be received by a server (e.g., the service provider server 502 shown in FIG. 5) associated with the first pool 402. In response to receiving the third customer request, the first pool 402 and/or the server may determine that the first pool 402 has the third contract 414 with the second farm 204 (by querying the blockchain ledger to identify the third contract 414 between the second farm 204 and the first pool 402, for example), determine that the second farm 204 has the third resource 214 that is the third type of resource, determine that the third resource 214 (and/or the third type of resource) is usable to perform the fourth service requested by the third customer request, and/or transmit a third allocation request to the second farm 204 (and/or to the client device associated with the second farm 204) which may request to allocate the third resource 214 to the third customer request. In some examples, in response to receiving the third allocation request, the third resource 214 may be allocated to the third customer request.

In some examples, one or more allocation operations may be performed to allocate the third resource 214 to the third customer request. In some examples, the one or more allocation operations may comprise transmitting (by the first pool 402, the server associated with the first pool 402, and/or the client device of the second farm 204, for example) an indication of the allocation of the third resource 214 to the third customer request to the blockchain network. In some examples, the one or more allocation operations may comprise recording (by the first pool 402, the server associated with the first pool 402, the client device of the second farm 204, and/or the third contract 414, for example) the allocation of the third resource 214 to the third customer request in the blockchain ledger. In some examples, the third resource 214 comprises a programmable device. The one or more allocation operations may comprise generating one or more commands for performing the fourth service and/or transmitting the one or more commands to the programmable device of the third resource 214.

In some examples, in response to allocating the third resource 214 to the third customer request, the third resource 214 may be used to perform and/or facilitate the fourth service. In an exemplary scenario, the fourth service may comprise a goods transportation service and/or the third resource 214 may comprise a truck used by the customer to transport goods. Other examples of the fourth service are within the scope of the present disclosure.

A third decentralized consensus mechanism may be used to determine a fourth value associated with fulfillment of the third customer request via performance of the fourth service by the third resource 214. In some examples, the third decentralized consensus mechanism may comprise a network of nodes (e.g., one or more types of computers). The fourth value may correspond to a pool income, a market capital, and/or a generated revenue associated with use of the third resource 214 to perform the fourth service. In some examples, the third decentralized consensus mechanism may evaluate performance of the fourth service to determine the fourth value.

The third decentralized consensus mechanism may evaluate performance of the fourth service and/or determine the fourth value based upon a set of information associated with the third resource 214 and/or the fourth service. The set of information (based upon which the third decentralized consensus mechanism determines the fourth value) may comprise one or more resource contribution and/or usage metrics associated with use of the third resource 214 to perform the fourth service, availability status associated with the third resource 214 (e.g., whether the third resource 214 is reserved or on-call), environmental conditions associated with the fourth service, risk management, insurance coverage, one or more customer satisfaction metrics, and/or other information. In some examples, the set of information may be provided to the third decentralized consensus mechanism by the third resource 214 (e.g., by the programmable device of the third resource 214), the second farm 204, the first pool 402, and/or other entity.

In some examples, the third decentralized consensus mechanism may use a third PoW model to determine the fourth value. In some examples, the third decentralized consensus mechanism may determine the third PoW model based upon (and/or may retrieve the third PoW model from) the third contract 414 (e.g., the third contract 414 may be indicative of the third PoW model). In some examples, the third PoW model may be executed by the third decentralized consensus mechanism to measure an amount that the third resource 214 contributes to revenue and/or common value of the first pool 402. In some examples, the third decentralized consensus mechanism may determine a revenue share and/or PoW share associated with the third resource 214 and/or the first pool 402 by executing the third PoW model based upon the set of information associated with the third resource 214 and/or the fourth service. In some examples, the revenue share may correspond to a proportion of revenue associated with (and/or derived from) the third resource 214 relative to total revenue associated with the first pool 402. In some examples, the PoW share may correspond to a proportion of PoW associated with the third resource 214 relative to total PoW associated with the first pool 402. In some examples, the revenue share and/or the PoW share may be used to determine the fourth value.

In some examples, the third PoW model may be configured based upon one or more third parameters including a third risk determination function related to the third type of resource (and/or the third resource 214), one or more third time-related coefficients related to the third type of resource (and/or the third resource 214), a third activity time function related to the third type of resource (and/or the third resource 214), a third correlation and integration function of a time available related to the third type of resource (and/or the third resource 214), a third income function related to the third type of resource (and/or the third resource 214), and/or a third customer satisfaction parameter related to the third type of resource (and/or the third resource 214).

In some examples, the fourth value may be determined according to

$$Pow ( V ) = \frac{R ( V )}{R ( P )} ( α \frac{T ( V )}{T ( P )} Inter ( V ) + β \frac{I ( V )}{I ( P )} \times \frac{S ( V )}{S ( P )} ) ,$$

where V corresponds to the third type of resource, P corresponds to the first pool 402, Pow(V) corresponds to the fourth value associated with the third resource 214 determined according to the third PoW model, R( ) corresponds to the third risk determination function (which may be based upon one or more factors such as one or more environmental factors and/or one or more other factors), a corresponds to a time-related coefficient of the one or more third time-related coefficients, T( ) corresponds to the third activity time function, Inter( ) corresponds to the third correlation and integration function of the time available, I( ) corresponds to the third income function (of a relevant domain, for example), and/or S( ) corresponds to the third customer satisfaction parameter. Embodiments are contemplated in which the fourth value is determined using the first decentralized consensus mechanism 602 and/or the first PoW model.

In some examples, a fourth transfer of a fourth asset to the second farm 204 may be executed based upon the fourth value (determined by the third decentralized consensus mechanism, for example). In some examples, executing the fourth transfer of the fourth asset includes executing a token payment, executing a digital coin payment, executing an NFT payment, transferring a real-world asset, transferring a stock share, and/or executing a Fiat payment.

In some examples, the third decentralized consensus mechanism may provide asset transfer instructions indicative of the fourth value to the asset management system 608. In some examples, the asset management system 608 may transfer the fourth asset to the second vault associated with the second farm 204. In some examples, the second vault may comprise a digital wallet, a bank account, a crypto wallet, a physical vault, a virtual vault, a payment account, a stored-value account, an E-money account, a P2P payment account, and/or other type of account and/or wallet. In some examples, the fourth asset may comprise a token, a digital coin, an NFT, a real-world asset, a stock share, rewards and/or loyalty points, credit, and/or Fiat. In some examples, an amount of the fourth asset may be based upon (and/or may be equal and/or equivalent to) the fourth value.

In some examples, a fourth resource 216 (shown in FIG. 2) associated with the second farm 204 may be determined. The fourth resource 216 may be the first type of resource (and/or a different type of resource). A fourth token may be generated for the first type of resource (and/or the different type of resource) and/or for the fourth resource 216, such as using one or more of the techniques provided herein with respect to generating the first token 306, the second token 304, and/or the third token. The fourth token may comprise a utility token, a security token, a payment token, an NFT, a stable Coin, a bearer token, a refresh token, an ID token, a JWT, a connected token, and/or a disconnected token. The fourth token may be allocated to the second farm 204. For example, the fourth token may be generated and/or allocated to the second farm 204 based upon the second farm 204 having the fourth resource 216 (which is the first type of resource and/or the different type of resource to which the fourth token is allocated, for example).

In some examples, the fourth contract 416 between the second farm 204 and the third pool 406 may be determined, such as using one or more of the techniques provided herein with respect to determining the first contract 410, the second contract 412, and/or the third contract 414. In some examples, the fourth contract 416 may comprise a fourth smart contract. The fourth contract 416 may comprise a fourth smart contract program (e.g., program code) and/or data indicative of rules for transactions, asset allocations, and/or participation records. The fourth contract 416 may be stored in one, some, or all nodes of the blockchain network. In some examples, the second farm 204 joins the fourth contract 416 (after the fourth contract 416 is deployed by the third pool 406, for example).

In some examples, responsive to a fourth customer request associated with a fifth service performable by the first type of resource (and/or the different type of resource), the fourth resource 216 of the second farm 204 may be allocated to the fourth customer request based upon the fourth contract 416. For example, the fourth resource 216 may be allocated to the fourth customer request in response to a determination that the second farm 204 has the fourth resource 216 that is the first type of resource (and/or the different type of resource) and/or that the fourth resource 216 (and/or the first type of resource and/or the different type of resource) is usable to perform the fifth service requested by the fourth customer request.

In some examples, a fourth decentralized consensus mechanism may be used to determine a fifth value associated with fulfillment of the fourth customer request via performance of the fifth service by the fourth resource 216. In some examples, the fourth decentralized consensus mechanism may comprise a network of nodes (e.g., one or more types of computers). The fifth value may correspond to a pool income, a market capital, and/or a generated revenue associated with use of the fourth resource 216 to perform the fifth service. In some examples, the fourth decentralized consensus mechanism may evaluate performance of the fifth service to determine the fifth value.

In some examples, the fourth decentralized consensus mechanism may use a fourth PoW model to determine the fifth value. In some examples, the fourth decentralized consensus mechanism may determine the fourth PoW model based upon (and/or may retrieve the fourth PoW model from) the fourth contract 416 (e.g., the fourth contract 416 may be indicative of the fourth PoW model). In some examples, the fourth PoW model may be executed by the fourth decentralized consensus mechanism to measure an amount that the fourth resource 216 contributes to revenue and/or common value of the third pool 406. In some examples, the fourth decentralized consensus mechanism may determine a revenue share and/or PoW share associated with the fourth resource 216 and/or the third pool 406 by executing the fourth PoW model based upon the set of information associated with the fourth resource 216 and/or the fifth service. In some examples, the revenue share may correspond to a proportion of revenue associated with (and/or derived from) the fourth resource 216 relative to total revenue associated with the third pool 406. In some examples, the PoW share may correspond to a proportion of PoW associated with the fourth resource 216 relative to total PoW associated with the third pool 406. In some examples, the revenue share and/or the PoW share may be used to determine the fifth value.

In some examples, the fourth PoW model may be configured based upon one or more fourth parameters including a fourth risk determination function related to the first type of resource (and/or the different type of resource and/or the fourth resource 216), one or more fourth time-related coefficients related to the first type of resource (and/or the different type of resource and/or the fourth resource 216), a fourth activity time function related to the first type of resource (and/or the different type of resource and/or the fourth resource 216), a fourth correlation and integration function of a time available related to the first type of resource (and/or the different type of resource and/or the fourth resource 216), a fourth income function related to the first type of resource (and/or the different type of resource and/or the fourth resource 216), and/or a fourth customer satisfaction parameter related to the first type of resource (and/or the different type of resource and/or the fourth resource 216).

In some examples, the fifth value may be determined according to

$$Pow ( V ) = \frac{R ( V )}{R ( P )} ( α \frac{T ( V )}{T ( P )} Inter ( V ) + β \frac{I ( V )}{I ( P )} \times \frac{S ( V )}{S ( P )} ) ,$$

where V corresponds to the first type of resource (and/or the different type of resource), P corresponds to the third pool 406, Pow(V) corresponds to the fifth value associated with the fourth resource 216 determined according to the fourth PoW model, R( ) corresponds to the fourth risk determination function (which may be based upon one or more factors such as one or more environmental factors and/or one or more other factors), a corresponds to a time-related coefficient of the one or more fourth time-related coefficients, T( ) corresponds to the fourth activity time function, Inter( ) corresponds to the fourth correlation and integration function of the time available, I( ) corresponds to the fourth income function (of a relevant domain, for example), and/or S( ) corresponds to the fourth customer satisfaction parameter. Embodiments are contemplated in which the fifth value is determined using the first decentralized consensus mechanism 602 and/or the first PoW model.

In some examples, a fifth transfer of a fifth asset to the second farm 204 (e.g., to the second vault associated with the second farm 204) may be executed based upon the fifth value (determined by the fourth decentralized consensus mechanism, for example). In some examples, executing the fifth transfer of the fifth asset includes executing a token payment, executing a digital coin payment, executing an NFT payment, transferring a real-world asset, transferring a stock share, and/or executing a Fiat payment. In some examples, the fifth asset may comprise a token, a digital coin, an NFT, a real-world asset, a stock share, rewards and/or loyalty points, credit, and/or Fiat. In some examples, an amount of the fifth asset may be based upon (and/or may be equal and/or equivalent to) the fifth value.

In some examples, a resource may be associated with more than one farm. For example, the resource may be associated with one farm in a defined period of time and another farm in another defined period of time. For example, the first resource 212 may be associated with the first farm 202 in a first defined period of time and may be associated with the second farm 204 in a second defined period of time. In some examples, the first defined period of time may be non-overlapping with the second defined period of time. In some examples, the first defined period of time and/or the second defined period of time may be determined based upon the fifth contract 420 between the first farm 202 and the second farm 204.

In some examples, the fifth contract 420 between the first farm 202 and the second farm 204 may be determined, such as using one or more of the techniques provided herein with respect to determining the first contract 410, the second contract 412, the third contract 414, and/or the fourth contract 416. In some examples, the fifth contract 420 may comprise a fifth smart contract. The fifth contract 420 may comprise a fifth smart contract program (e.g., program code) and/or data indicative of rules for transactions, asset allocations, and/or participation records. The fifth contract 420 may be stored in one, some, or all nodes of the blockchain network. In some examples, the second farm 204 joins the fifth contract 420 after the fifth contract 420 is deployed by the first farm 202. In some examples, the first farm 202 joins the fifth contract 420 after the fifth contract 420 is deployed by the second farm 204. In some examples, the fifth contract 420 may be indicative of information (e.g., timing information) usable to determine the first defined period of time and/or the second defined period of time. For example, the information may be indicative of start times and/or end times of the first defined period of time and/or the second defined period of time. Alternatively and/or additionally, the information may be indicative of a first time share that the first resource 212 is allocated to and/or associated with the first farm 202 and/or a second time share that the first resource 212 is allocated to and/or associated with the second farm 204. In an example scenario, the first time share may be 30% and/or the second time share may be 70% (e.g., the first resource 212 may be allocated to and/or associated with the first farm 202 for 3 days of a period of 10 days and/or may be allocated to and/or associated with the second farm 204 for the remaining 7 days of the period of 10 days).

In some examples, the first customer request 504 (shown in FIG. 5) may be received during the first defined period of time. Alternatively and/or additionally, the first service requested by the first customer request 504 may be scheduled for and/or performed during the first defined period of time. For example, the allocation request 508 may be transmitted to the first farm 202 (and/or to the client device 302 associated with the first farm 202) based upon a determination that the first resource 212 (usable to perform the first service requested by the first customer request 504) is associated with the first farm 202 during the first defined period of time, and/or that the first service requested by the first customer request 504 is scheduled to be performed during the first defined period of time (and/or that the first customer request 504 is received during the first defined period of time). In some examples, the first contract 410 may define a first relationship between the first farm 202 and the first pool 402 in the first defined period of time.

In some examples, a fifth customer request associated with a sixth service performable by the first type of resource may be received (by the service provider server 502 associated with the first pool 402, for example). In some examples, the fifth customer request may be received during the second defined period of time. Alternatively and/or additionally, the sixth service may be scheduled for a time during the second defined period of time (and/or the fifth customer request may be indicative of the time during the second defined period of time). In some examples, the first resource 212 may be allocated to the fifth customer request based upon the third contract 414 between the second farm 204 and the first pool 402. In some examples, the third contract 414 may define a second relationship between the second farm 204 and the first pool 402 in the second defined period of time.

For example, the third contract 414 associated with the second farm 204 may be used (to allocate the first resource 212 from the second farm 204 to the fifth customer request, for example) based upon a determination that the sixth service is scheduled for a time during the second defined period of time and/or that the fifth customer request was received during the second defined period of time. For example, the first resource 212 may be allocated to the fifth customer request in response to a determination that the second farm 204 has the first resource 212 that is the first type of resource during the second defined period of time and/or that the first resource 212 (and/or the first type of resource) is usable to perform the sixth service requested by the fifth customer request.

In some examples, a fifth decentralized consensus mechanism may be used to determine a sixth value associated with fulfillment of the fifth customer request via performance of the sixth service by the first resource 212. In some examples, the fifth decentralized consensus mechanism may comprise a network of nodes (e.g., one or more types of computers). The sixth value may correspond to a pool income, a market capital, and/or a generated revenue associated with use of the first resource 212 to perform the sixth service. In some examples, the fifth decentralized consensus mechanism may evaluate performance of the sixth service to determine the sixth value. In some examples, the fifth decentralized consensus mechanism may use a fifth PoW model to determine the sixth value. Embodiments are contemplated in which the sixth value is determined using the first decentralized consensus mechanism 602 and/or the first PoW model.

In some examples, a sixth transfer of a sixth asset to the second farm 204 (e.g., to the second vault associated with the second farm 204) may be executed based upon the sixth value (determined by the fifth decentralized consensus mechanism, for example). In some examples, executing the sixth transfer of the sixth asset includes executing a token payment, executing a digital coin payment, executing an NFT payment, transferring a real-world asset, transferring a stock share, and/or executing a Fiat payment. In some examples, the sixth asset may comprise a token, a digital coin, an NFT, a real-world asset, a stock share, rewards and/or loyalty points, credit, and/or Fiat. In some examples, an amount of the sixth asset may be based upon (and/or may be equal and/or equivalent to) the sixth value.

In some examples, a sixth customer request associated with a seventh service performable by the first type of resource may be received (by a server associated with the third pool 406, for example). In some examples, the sixth customer request may be received during the second defined period of time. Alternatively and/or additionally, the seventh service may be scheduled for a time during the second defined period of time (and/or the sixth customer request may be indicative of the time during the second defined period of time). In some examples, the first resource 212 may be allocated to the sixth customer request based upon the fourth contract 416 between the second farm 204 and the third pool 406. In some examples, the fourth contract 416 may define a third relationship between the second farm 204 and the third pool 406 in the second defined period of time.

For example, the fourth contract 416 associated with the second farm 204 may be used (to allocate the first resource 212 from the second farm 204 to the sixth customer request, for example) based upon a determination that the seventh service is scheduled for a time during the second defined period of time and/or that the sixth customer request was received during the second defined period of time. For example, the first resource 212 may be allocated to the sixth customer request in response to a determination that the second farm 204 has the first resource 212 that is the first type of resource during the second defined period of time and/or that the first resource 212 (and/or the first type of resource) is usable to perform the seventh service requested by the sixth customer request.

In some examples, a sixth decentralized consensus mechanism may be used to determine a seventh value associated with fulfillment of the sixth customer request via performance of the seventh service by the first resource 212. In some examples, the sixth decentralized consensus mechanism may comprise a network of nodes (e.g., one or more types of computers). The seventh value may correspond to a pool income, a market capital, and/or a generated revenue associated with use of the first resource 212 to perform the seventh service. In some examples, the sixth decentralized consensus mechanism may evaluate performance of the seventh service to determine the seventh value. In some examples, the sixth decentralized consensus mechanism may use a sixth PoW model to determine the seventh value. Embodiments are contemplated in which the seventh value is determined using the first decentralized consensus mechanism 602 and/or the first PoW model.

In some examples, a seventh transfer of a seventh asset to the second farm 204 (e.g., to the second vault associated with the second farm 204) may be executed based upon the seventh value (determined by the sixth decentralized consensus mechanism, for example). In some examples, executing the seventh transfer of the seventh asset includes executing a token payment, executing a digital coin payment, executing an NFT payment, transferring a real-world asset, transferring a stock share, and/or executing a Fiat payment. In some examples, the seventh asset may comprise a token, a digital coin, an NFT, a real-world asset, a stock share, rewards and/or loyalty points, credit, and/or Fiat. In some examples, an amount of the seventh asset may be based upon (and/or may be equal and/or equivalent to) the seventh value.

In some examples, responsive to the first customer request 504 (shown in FIG. 5) being associated with an eighth service performable by the third type of resource (in addition to the first customer request 504 being associated with the first service performable by the first type of resource and/or being associated with the second service performable by the second type of resource, for example), the third resource 214 may be allocated to the first customer request 504. In some examples, the third resource 214 may be allocated to the first customer request 504 based upon determining (in response to the first customer request 504, for example) that the first pool 402 has the third contract 414 with the second farm 204, that the second farm 204 has the third resource 214 that is the third type of resource, and/or that the third resource 214 (and/or the third type of resource) is usable to perform the eighth service requested by the first customer request 504. The service provider of the first service may provide the eighth service (in addition to providing the first service and/or the second service, for example). The first customer request 504 may be indicative of the eighth service.

In some examples, in response to receiving the first customer request 504, the service provider server 502 may determine that the first pool 402 has the third contract 414 with the second farm 204 (by querying the blockchain ledger to identify the third contract 414 between the second farm 204 and the first pool 402, for example), determine that the second farm 204 has the third resource 214 that is the third type of resource, determine that the third resource 214 (and/or the third type of resource) is usable to perform the eighth service requested by the first customer request 504, and/or transmit a fourth allocation request to the second farm 204 (and/or to a client device associated with the second farm 204) which may request to allocate the third resource 214 to the first customer request 504. In some examples, in response to receiving the fourth allocation request, the third resource 214 may be allocated to the first customer request 504.

In some examples, a seventh decentralized consensus mechanism may be used to determine an eighth value associated with fulfillment of the first customer request 504 via performance of the eighth service by the third resource 214. In some examples, the seventh decentralized consensus mechanism may comprise a network of nodes (e.g., one or more types of computers). The eighth value may correspond to a pool income, a market capital, and/or a generated revenue associated with use of the third resource 214 to perform the eighth service. In some examples, the seventh decentralized consensus mechanism may evaluate performance of the eighth service to determine the eighth value. In some examples, the seventh decentralized consensus mechanism may use a seventh PoW model to determine the eighth value. Embodiments are contemplated in which the eighth value is determined using the first decentralized consensus mechanism 602 and/or the first PoW model.

In some examples, an eighth transfer of an eighth asset to the second farm 204 (e.g., to the second vault associated with the second farm 204) may be executed based upon the eighth value (determined by the seventh decentralized consensus mechanism, for example). In some examples, executing the eighth transfer of the eighth asset includes executing a token payment, executing a digital coin payment, executing an NFT payment, transferring a real-world asset, transferring a stock share, and/or executing a Fiat payment. In some examples, the eighth asset may comprise a token, a digital coin, an NFT, a real-world asset, a stock share, rewards and/or loyalty points, credit, and/or Fiat. In some examples, an amount of the eighth asset may be based upon (and/or may be equal and/or equivalent to) the eighth value.

In some examples, a financing entity, such as a financing company, a pool of the plurality of pools, a bank, an investor, an innovation entity, etc. may provide financing for one or more farms, which may enable the one or more farms to at least one of expand operations, purchase new resources, upgrade existing resources, etc. In some examples, generated data (e.g., income, transfers of assets, etc.) from parties of the ecosystem (e.g., pools and/or farms) may be accessible to the financial entity via the blockchain network and/or the blockchain ledger, thereby enabling the financial entity to have increased insights into operation of a farm and/or pool and/or determine financing values with increased accuracy and/or confidence.

In some examples, a financing value for the first farm 202 may be determined based upon a value of one or more tokens of the first farm 202 and/or an income of the first farm 202. In some examples, the income and/or the value of the one or more tokens of the first farm 202 may be determined by accessing the blockchain ledger (and/or querying the blockchain ledger to provide an indication of the income and/or the value of the one or more tokens). In some examples, a financing transfer from the financing entity to the first farm 202 may be executed based upon the financing value. Executing the financing transfer may comprise executing a token payment, executing a digital coin payment, executing an NFT payment, transferring a real-world asset, transferring a stock share, and/or executing a Fiat payment. In some examples, the one or more tokens may be provided to the financing company as collateral (for the financing transfer, for example).

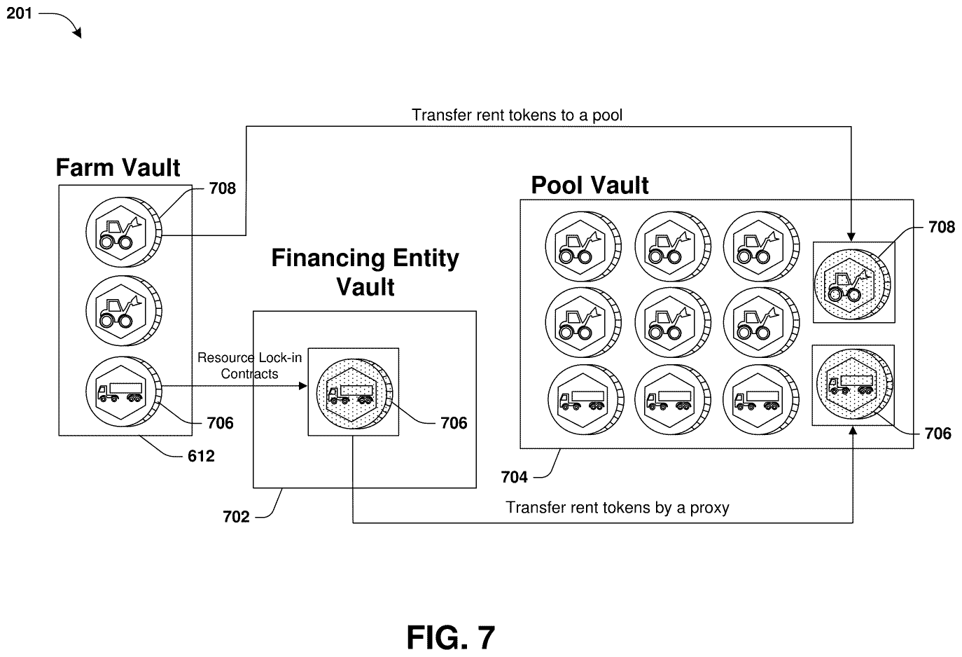

FIG. 7 illustrates interactions of the financing entity, the first pool 402 and/or the first farm 202. For example, the one or more tokens (based upon which the financing value is determined, for example) may comprise a token 706 (shown in FIG. 7) transferred from the vault 612 associated with the first farm 202 to a financing vault 702 associated with the financing entity. In some examples, the financing vault 702 may comprise a digital wallet, a bank account, a crypto wallet, a physical vault, a virtual vault, a payment account, a stored-value account, an E-money account, a P2P payment account, and/or other type of account and/or wallet.

In some examples, the first farm 202 may join a smart contract between the financing entity and the first pool 402. In some examples, the smart contract may enable the financing entity to enforce settlement conditions automatically, such as by withdrawing and/or taking ownership of the token 706 in response to a loan default. In some examples, the financing entity may be authorized by the smart contract to execute proxy transfers of one or more rent tokens (e.g., the token 706) to a pool vault 704 associated with the first pool 402. In some examples, the first farm 202 may directly transfer one or more rent tokens (e.g., a token 708 from the vault 612 associated with the first farm 202) to the pool vault 704 associated with the first pool 402.

In some examples, a resource (e.g., the first resource 212, the second resource 210, the third resource 214, the fourth resource 216, etc.) provided herein may comprise at least one of a ground vehicle, a sea transport vessel, an air vehicle, a space vehicle, a computing device (e.g., a phone, a laptop, a desktop computer, a super-computer, etc.), an apartment building, an apartment unit, a condo, a house, an object usable to perform a service, etc.

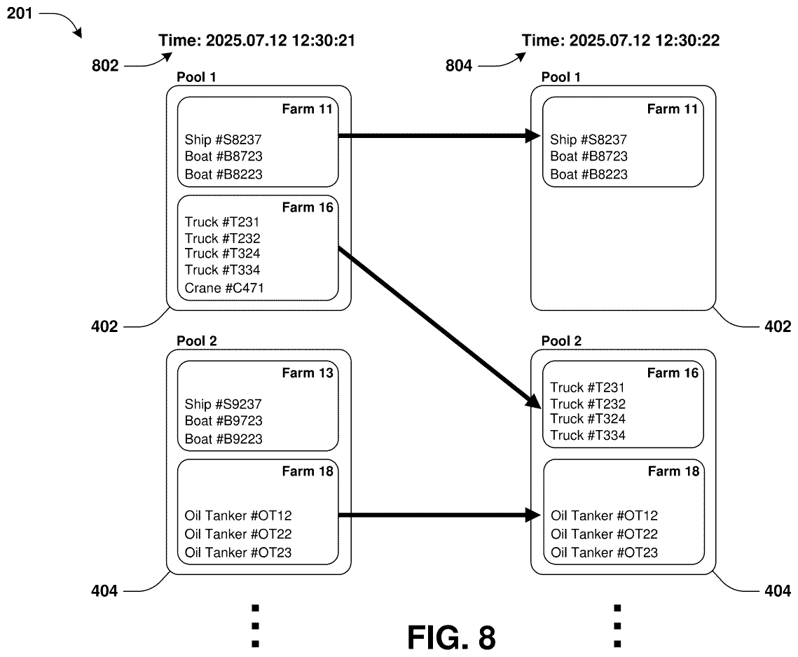

In some examples, farms associated with a pool may change over time. FIG. 8 illustrates farms associated with the first pool 402 and the second pool 404 changing from a first time 802 to a second time 804. For example, at the first time 802, the first pool 402 may be associated with Farm 11 and Farm 16 (e.g., the first pool 402 may have smart contracts with Farm 11 and Farm 16), and the second pool 404 may be associated with Farm 13 and Farm 18 (e.g., the second pool 404 may have smart contracts with Farm 13 and Farm 18). At the second time 804, the first pool 402 may be associated with Farm 11 (e.g., the first pool 402 may have a smart contract with Farm 11), and the second pool 404 may be associated with Farm 16 and Farm 18 (e.g., the second pool 404 may have smart contracts with Farm 16 and Farm 18).

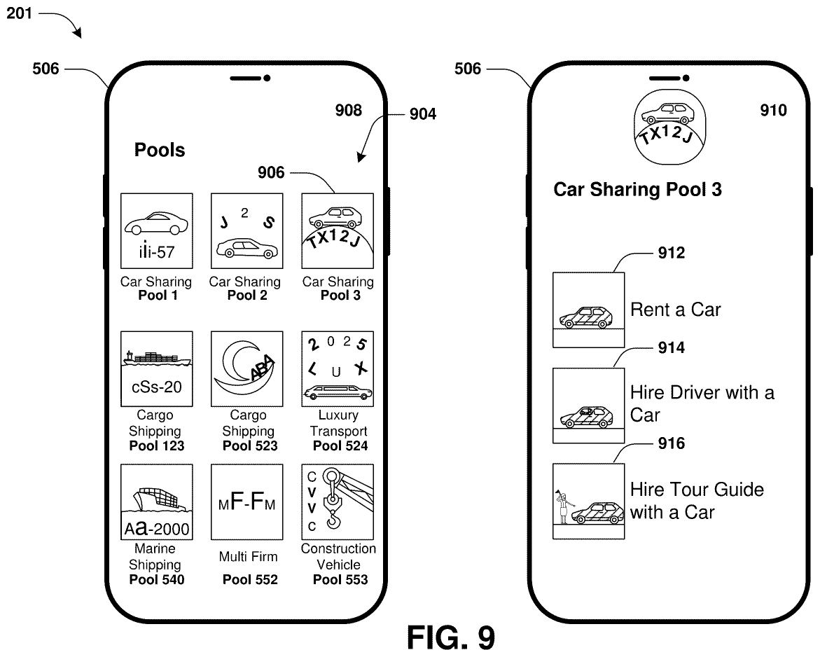

FIG. 9 illustrates the customer device 506 displaying a pool selection interface 908. The pool selection interface 908 may comprise a plurality of selectable inputs 904. In some examples, each selectable input of the plurality of selectable inputs 904 may be associated with a pool of a plurality of pools associated with the ecosystem. In some examples, in response to a selection of a selectable input 906 associated with a pool, the customer device 506 may display a service selection interface 910 comprising selectable inputs for selecting a service offered by the pool. In an example, the selectable inputs of the service selection interface 910 may comprise a selectable input 912 associated with a service for renting a car, a selectable input 914 associated with a service for hiring a driver with a car, and/or a selectable input 916 associated with a service for hiring a tour guide with a car. In some examples, the first customer request 504 may be received in response to a selection of a selectable input (e.g., the selectable input 912) of the service selection interface 910.

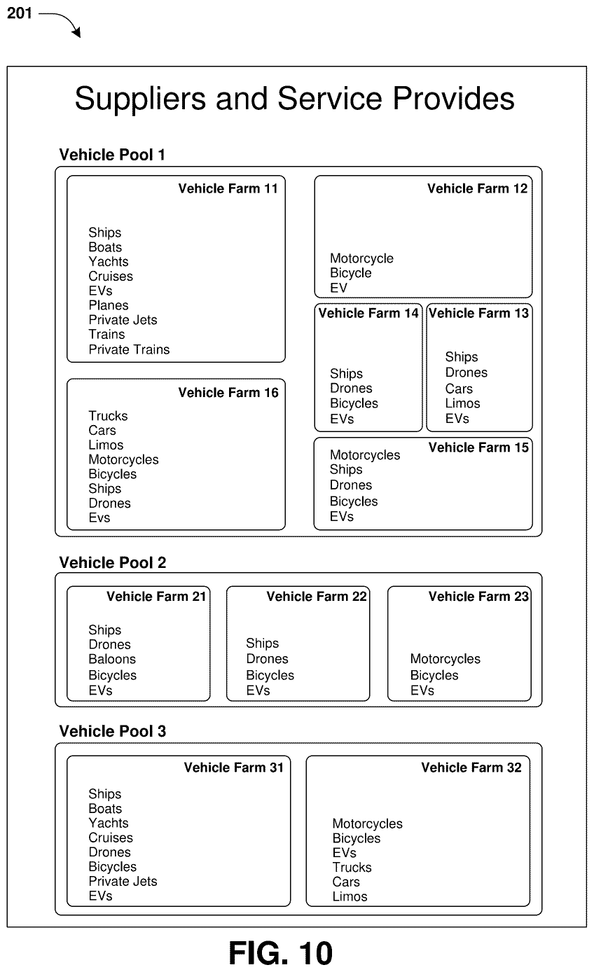

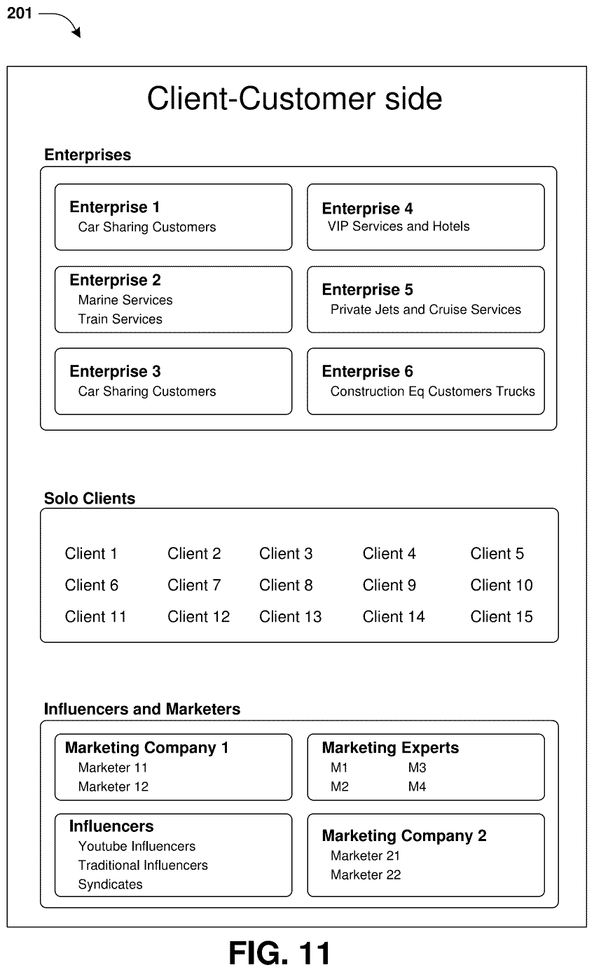

FIG. 10 illustrates representations of pools in the ecosystem and/or farms associated with the pools. For example, the pools may include Vehicle Pool 1 that is associated with (e.g., has contracts with) Vehicle Farm 11, Vehicle Farm 12, Vehicle Farm 13, Vehicle Farm 14, Vehicle Farm 15, and/or Vehicle Farm 16. FIG. 11 illustrates a representation of customers and/or users of the ecosystem. For example, the users may include one or more enterprises (e.g., Enterprise 1, Enterprise 2, etc.), and/or one or more influencers and/or marketers (e.g., Marketing Company 1, Influencers, etc.). Alternatively and/or additionally, the customers may include solo clients (e.g., Client 1, Client 2, etc.).

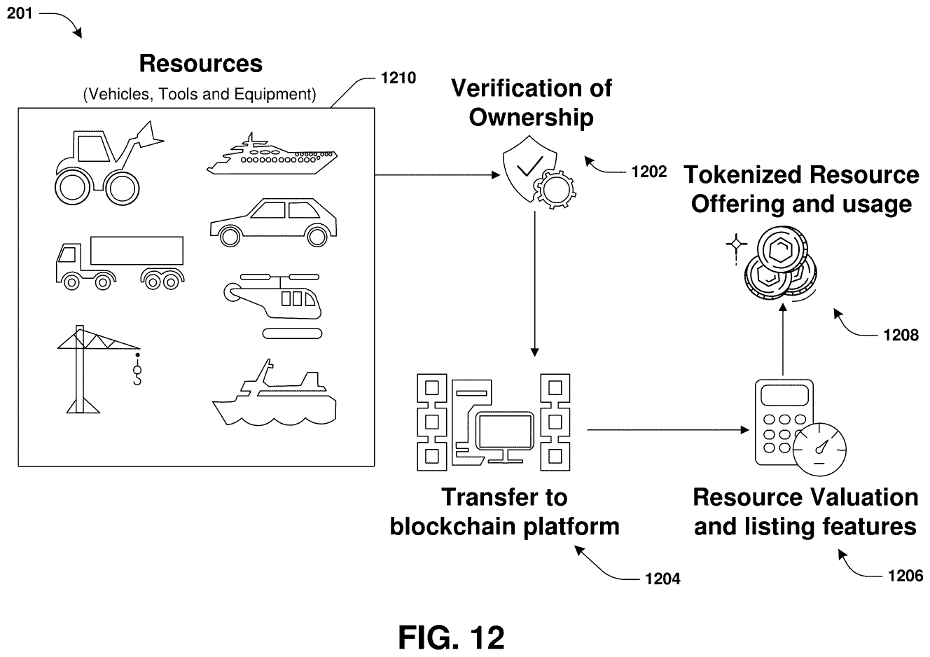

FIG. 12 illustrates an environment in which the system 201 and/or the ecosystem operate. In some examples, resources 1210 may undergo a verification of ownership process 1202 to ensure that a resource introduced to the ecosystem has been authenticated and/or its legal control confirmed prior to tokenization. In response to verifying ownership, a resource may be transferred to a blockchain platform at 1204, such as by transmitting a digital entry indicative of the resource to the blockchain network of the blockchain platform and/or recording the digital entry in the blockchain ledger, thereby providing for transparent record-keeping of resource-related activities, including transfers, allocations, and modifications. Resources may be added or removed from the ecosystem by minting or burning associated tokens in the blockchain platform. In some examples, the system 201 may perform resource valuation and/or listing features at 1206, where a value of a resource may be assessed and/or listing data may be prepared for integration into the ecosystem, such as by establishing pricing metrics, performance disclosures, participation criteria, levels of transparency, etc. (depending on policies of a pool and/or the ecosystem, for example). In some examples, a pool may be required to disclose conditions and/or constraints associated with farms and/or resources (when the pool joins the ecosystem, for example) such that a farm is aware of the conditions and/or the constraints prior to joining the pool. In some examples, in response to the resource valuation and/or the listing features at 1206, tokens representing ownership and/or usage rights of resources may be offered, allocated, exchanged, used, and/or tracked (transparently using the blockchain platform, for example) at 1208. For example, at 1208, the tokenized resources may be bought, sold, transferred among participants, and/or allocated into pools. Thus, participants (e.g., pools and/or farms) may benefit from transparent tracking, collective investment scalability, and/or risk control.

In some examples, a method is provided. The method includes determining a first resource associated with a first farm, wherein the first resource is a first type of resource, generating a first token for the first type of resource, allocating the first token to the first farm, determining a first contract between the first farm and a first pool, responsive to a first customer request associated with a first service performable by the first type of resource, allocating the first resource to the first customer request based upon the first contract, using a first decentralized consensus mechanism, determining a first value associated with fulfillment of the first customer request via performance of the first service by the first resource, and executing a first transfer of a first asset to the first farm based upon the first value.

In some examples, the method includes determining a second resource associated with a second farm, wherein the second resource is a second type of resource, generating a second token for the second type of resource, allocating the second token to the second farm, determining a second contract between the second farm and the first pool, responsive to a second customer request associated with a second service performable by the second type of resource, allocating the second resource of the second farm to the second customer request based upon the second contract, using a second decentralized consensus mechanism, determining a second value associated with fulfillment of the second customer request via performance of the second service by the second resource, and executing a second transfer of a second asset to the second farm based upon the second value.

In some examples, the method includes determining a second resource associated with a second farm, wherein the second resource is a second type of resource, generating a second token for the second type of resource, allocating the second token to the second farm, determining a second contract between the second farm and a second pool, responsive to a second customer request associated with a second service performable by the second type of resource, allocating the second resource of the second farm to the second customer request based upon the second contract, using a second decentralized consensus mechanism, determining a second value associated with fulfillment of the second customer request via performance of the second service by the second resource, and executing a second transfer of a second asset to the second farm based upon the second value.

In some examples, the method includes determining a second resource associated with a second farm, wherein the second resource is a second type of resource, generating a second token for the second type of resource, allocating the second token to the second farm, determining a second contract of the second farm, responsive to the first customer request also being associated with a second service performable by the second type of resource, allocating the second resource to the first customer request based upon the second contract, using a second decentralized consensus mechanism, determining a second value associated with fulfillment of the first customer request via performance of the second service by the second resource, and executing a second transfer of a second asset to the second farm based upon the second value.

In some examples, the method includes determining a second resource associated with the first farm, wherein the second resource is a second type of resource, generating a second token for the second type of resource, allocating the second token to the first farm, responsive to the first customer request also being associated with a second service performable by the second type of resource, allocating the second resource to the first customer request based upon the first contract, using the first decentralized consensus mechanism, determining a second value associated with fulfillment of the first customer request via performance of the second service by the second resource, and executing a second transfer of a second asset to the first farm based upon the second value.

In some examples, the method includes determining a second contract between the first farm and a second pool, responsive to a second customer request associated with a second service performable by the first type of resource, allocating the first resource of the first farm to the second customer request based upon the second contract, using a second decentralized consensus mechanism, determining a second value associated with fulfillment of the second customer request via performance of the second service by the first resource, and executing a second transfer of a second asset to the first farm based upon the second value.

In some examples, the first resource is associated with the first farm in a first defined period of time, and the method includes determining that the first resource is associated with a second farm in a second defined period of time, determining a second contract between the second farm and a second pool, responsive to a second customer request associated with a second service performable by the first type of resource in the second defined period of time, allocating the first resource to the second customer request based upon the second contract, using a second decentralized consensus mechanism, determining a second value associated with fulfillment of the second customer request via performance of the second service by the first resource, and executing a second transfer of a second asset to the second farm based upon the second value.

In some examples, the first contract defines a first relationship between the first farm and the first pool in a first defined period of time and the method includes determining a second contract defining a second relationship between a second farm and the first pool in a second defined period of time.

In some examples, executing the first transfer of the first asset includes executing a first token payment, executing a first digital coin payment, executing a first Non-Fungible Token (NFT) payment, transferring a first real-world asset, transferring a first stock share, and/or executing a first Fiat payment.

In some examples, executing the second transfer of the second asset includes executing a second token payment, executing a second digital coin payment, executing a second Non-Fungible Token (NFT) payment, transferring a second real-world asset, transferring a second stock share, and/or executing a second Fiat payment.

In some examples, the first token includes a first utility token, a first security token, a first payment token, a first Non-Fungible Token (NFT), a first stable Coin, a first bearer token, a first refresh token, a first ID token, a first JSON web token (JWT), a first connected token, and/or a first disconnected token.

In some examples, the first resource includes a programmable device, and allocating the first resource to the first customer request includes generating one or more commands for performing the first service and transmitting the one or more commands to the programmable device.

In some examples, the first resource includes a first ground vehicle, a first sea transport vessel, a first air vehicle, and/or a first space vehicle.

In some examples, the first decentralized consensus mechanism comprises a first proof of work (PoW) model, and the second decentralized consensus mechanism comprises a second PoW model.

In some examples, the first PoW model is configured based upon one or more first parameters including a first risk determination function related to the first type of resource, one or more first time-related coefficients related to the first type of resource, a first activity time function related to the first type of resource, a first correlation and integration function of a time available related to the first type of resource, a first income function related to the first type of resource, and/or a first customer satisfaction parameter related to the first type of resource. In some examples, the second PoW model is configured based upon one or more second parameters including a second risk determination function related to the second type of resource, one or more second time-related coefficients related to the second type of resource, a second activity time function related to the second type of resource, a second correlation and integration function of a time available second type of resource, a second income function related to the second type of resource, and/or a second customer satisfaction parameter related to the second type of resource.

In some examples, the method includes determining a value of one or more tokens of the first farm, determining an income of the first farm, determining a financing value for the first farm based upon the value of the one or more tokens of the first farm and the income of the first farm, executing a financing transfer from a financing entity to the first farm based upon the financing value, and providing the one or more tokens of the first farm as collateral to the financing entity.

In some examples, the method includes determining, via a second decentralized consensus mechanism, a first reward for a first customer from which the first customer request was received, and executing a second transfer to the first customer based upon the first reward.

In some examples, the method includes prior to the first contract between the first farm and the first pool, determining, via a second decentralized consensus mechanism, a first expected revenue for the first resource in association with the first pool, and presenting the first expected revenue to the first farm.

In some examples, the method includes receiving a request, from an owner of the first resource, to allocate a defined portion of the first resource to the first farm.

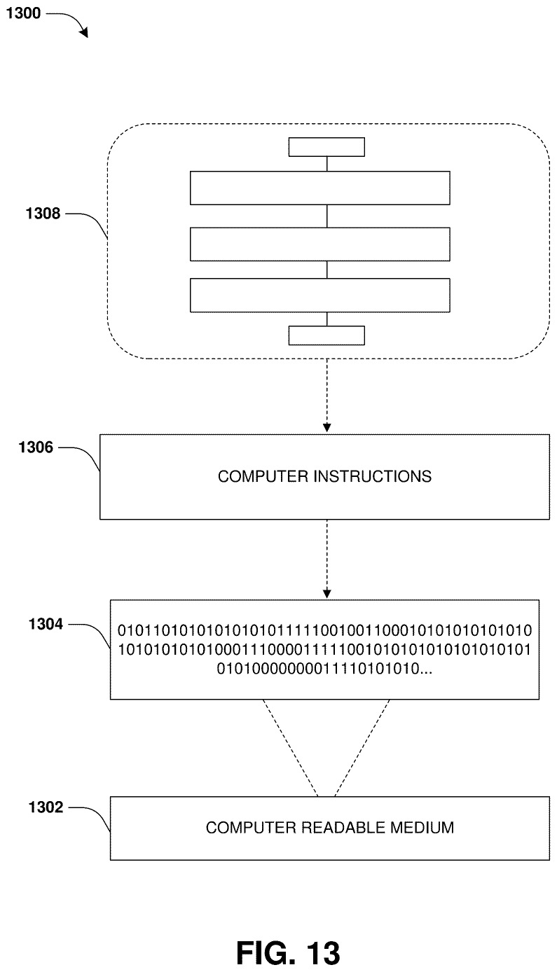

Another embodiment involves a computer-readable medium comprising processor-executable instructions. The processor-executable instructions may be configured to implement one or more of the techniques presented herein. An exemplary computer-readable medium that may be devised in these ways is illustrated in FIG. 13. An implementation 1300 may comprise a computer-readable medium 1302 (e.g., a CD, DVD, or at least a portion of a hard disk drive), which may comprise encoded computer-readable data 1304. The computer-readable data 1304 comprises a set of computer instructions 1306 configured to operate according to one or more of the principles set forth herein. In one such embodiment 1300, the processor-executable computer instructions 1306 may be configured to perform a method 1308, such as at least some of the example method 100 of FIG. 1, for example. In another such embodiment, the processor-executable instructions 1306 may be configured to implement a system, such as at least some of the system 201 of FIGS. 2-12, for example. Many such computer-readable media 1302 may be devised by those of ordinary skill in the art that are configured to operate in accordance with the techniques presented herein.

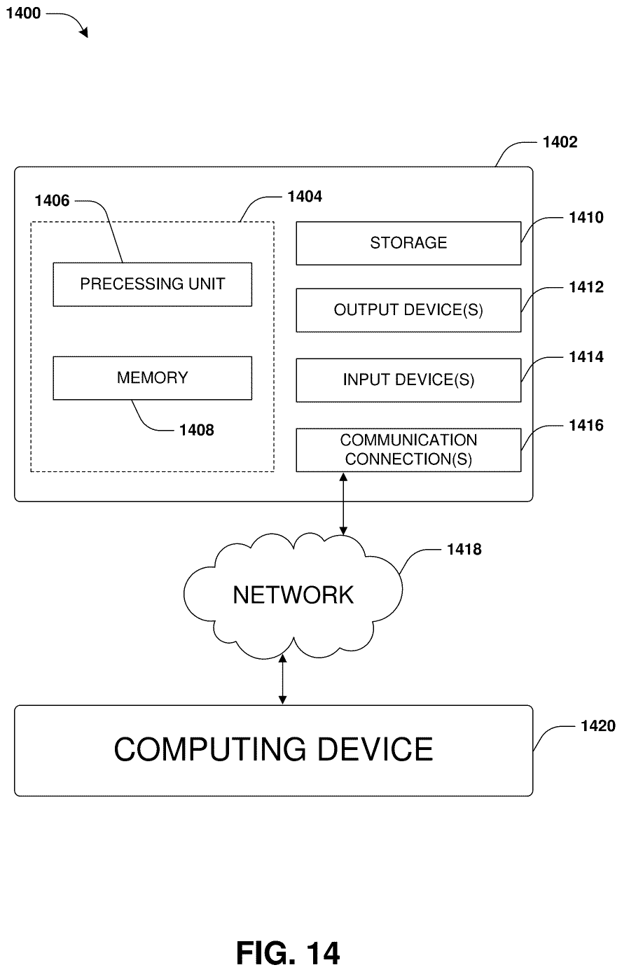

FIG. 14 and the following discussion provide a description of a suitable computing environment to implement embodiments of one or more of the provisions set forth herein. The operating environment of FIG. 14 is just one example of a suitable operating environment and is not intended to indicate any limitation as to the scope of use or functionality of the operating environment. Example computing devices include, but are not limited to, server computers, mainframe computers, personal computers, hand-held or laptop devices, mobile devices (such as mobile phones, Personal Digital Assistants (PDAs), media players, and the like), consumer electronics, multiprocessor systems, mini computers, distributed computing environments that include any of the above systems or devices, and the like.

Although not required, embodiments are described in the general context of “computer readable instructions” being executed by one or more computing devices. Computer readable instructions may be distributed using computer readable media (discussed below). Computer readable instructions may be implemented as programs and/or program modules, such as functions, objects, Application Programming Interfaces (APIs), data structures, and the like, that execute particular tasks or implement particular abstract data types. Typically, the functionality of the computer readable instructions may be combined or distributed (e.g., as desired) in various environments.

FIG. 14 illustrates an example of a system 1400 comprising a (e.g., computing) device 1402. Device 1402 may be configured to implement one or more embodiments provided herein. In an exemplary configuration, device 1402 includes at least one processing unit 1406 and at least one memory 1408. Depending on the configuration and type of computing device, memory 1408 may be volatile (such as RAM, for example), non-volatile (such as ROM, flash memory, etc., for example), or some combination of volatile and non-volatile. This configuration is illustrated in FIG. 14 by dashed line 1404.

In other embodiments, device 1402 may include additional features and/or functionality. For example, device 1402 may further include additional storage (e.g., removable and/or non-removable) including, but not limited to, magnetic storage, optical storage, and the like. Such additional storage is illustrated in FIG. 14 by storage 1410. In one embodiment, computer readable instructions to implement one or more embodiments provided herein may be in storage 1410. Storage 1410 may further store other computer readable instructions to implement an application program, an operating system, and the like. Computer readable instructions may be loaded in memory 1408 for execution by processing unit 1406, for example.

The term “computer readable media” as used herein includes computer storage media. Computer storage media includes volatile and/or nonvolatile, removable and/or non-removable media implemented in any method or technology for storage of information such as computer readable instructions or other data. Memory 1408 and storage 1410 are examples of computer storage media. Computer storage media may include, but is not limited to including, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store desired information and can be accessed by device 1402. Any such computer storage media may be part of device 1402.

Device 1402 may further include communication connection(s) 1416 that allows device 1402 to communicate with other devices. Communication connection(s) 1416 may include, but is not limited to including, a modem, a radio frequency transmitter/receiver, an integrated network interface, a Network Interface Card (NIC), a USB connection, an infrared port, or other interfaces for connecting device 1402 to other computing devices. Communication connection(s) 1416 may include a wireless connection and/or a wired connection. Communication connection(s) 1416 may transmit and/or receive communication media.

The term “computer readable media” may include, but is not limited to including, communication media. Communication media typically embodies computer readable instructions and/or other data in a “modulated data signal” such as a carrier wave or other transport mechanism and includes any information delivery media. The term “modulated data signal” may correspond to a signal that has one or more of its characteristics set or changed in such a manner as to encode information in the signal.

Device 1402 may include input device(s) 1414 such as mouse, keyboard, voice input device, pen, infrared cameras, touch input device, video input devices, and/or any other input device. Output device(s) 1412 such as one or more displays, speakers, printers, and/or any other output device may also be included in device 1402. Input device(s) 1414 and output device(s) 1412 may be connected to device 1402 using a wireless connection, wired connection, or any combination thereof. In one embodiment, an input device or an output device from another computing device may be used as input device(s) 1414 or output device(s) 1412 for device 1402.

Components of device 1402 may be connected by various interconnects (e.g., such as a bus). Such interconnects may include a Peripheral Component Interconnect (PCI), such as a Universal Serial Bus (USB), PCI Express, an optical bus structure, firewire (IEEE 1394), and the like. In another embodiment, components of device 1402 may be interconnected by a network. In an example, memory 1408 may be comprised of multiple (e.g., physical) memory units located in different physical locations interconnected by a network.

Storage devices utilized to store computer readable instructions may be distributed across a network. For example, a computing device 1420 accessible using a network 1418 may store computer readable instructions to implement one or more embodiments provided herein. Device 1402 may access computing device 1420 and download a part or all of the computer readable instructions for execution. Alternatively, device 1402 may download pieces of the computer readable instructions, as needed, or some instructions may be executed at device 1402 and some at computing device 1420.

Various operations of embodiments are provided herein. In one embodiment, one or more of the operations described may comprise computer readable instructions stored on one or more computer readable media, which if executed by a computing device, will cause the computing device to perform the operations described. The order in which some or all of the operations are described should not be construed as to imply that these operations are order dependent. Alternative ordering will be appreciated by one skilled in the art having the benefit of this description. Further, it will be understood that not all operations are present in each embodiment provided herein.

Although the subject matter has been described in language specific to structural features and/or methodological acts, it is to be understood that the subject matter defined in the appended claims is not limited to the specific features or acts described above. Rather, the specific features and acts described above are disclosed as example forms of implementing the claims.

As used in this application, the terms “system”, “component,” “interface”, “module,” and the like are generally intended to refer to a computer-related entity, either hardware, software, a combination of hardware and software, or software in execution. For example, a component may be, but is not limited to being, an object, a process running on a processor, a processor, a program, an executable, a thread of execution, and/or a computer. By way of illustration, an application running on a controller and the controller can be a component. One or more components may reside within a thread of execution and/or process and a component may be distributed between two or more computers and/or localized on one computer.

Furthermore, the claimed subject matter may be implemented as an apparatus, method, and/or article of manufacture using standard programming and/or engineering techniques to produce hardware, firmware, software, or any combination thereof to control a computer that may implement the disclosed subject matter. The term “article of manufacture” as used herein is intended to encompass a computer program (e.g., accessible from any computer-readable device, carrier, or media). Of course, those skilled in the art will recognize many modifications may be made to this configuration without departing from the scope or spirit of the claimed subject matter.

Moreover, the word “exemplary” is used herein to mean serving as an example, illustration, or instance. Any design or aspect described herein as “exemplary” is not necessarily to be construed as advantageous over other designs or aspects. Rather, use of the word “exemplary” is intended to present concepts in a concrete fashion. As used in this application, the word “or” is intended to mean an inclusive “or” (e.g., rather than an exclusive “or”). That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the words “a” and “an” as used in this application and the appended claims may generally be construed to mean “one or more” (e.g., unless specified otherwise or clear from context to be directed to a singular form). Also, at least one of A or B or the like generally means A or B or both A and B. Furthermore, to the extent that the terms “includes”, “having”, “has”, “with”, or variants thereof are used in either the detailed description or the claims, such terms are intended to be inclusive in a manner similar to the term “comprising.”

Although the disclosure has been shown and described with respect to one or more implementations, modifications and alterations will occur to others skilled in the art based (e.g., at least in part) upon a reading of this specification and the annexed drawings. The disclosure includes all such modifications and alterations. The disclosure is limited only by the scope of the following claims. In regard to the various functions performed by the above described components (e.g., resources, elements, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. Additionally, while a particular feature of the disclosure may have been disclosed with respect to only one of several implementations, the particular feature may be combined with one or more other features of the other implementations as may be desired and/or advantageous for any given or particular application.

What is claimed is:

1. A method, comprising:
determining a first resource associated with a first farm, wherein the first resource is a first type of resource;
generating a first token for the first type of resource;
allocating the first token to the first farm;
determining a first contract between the first farm and a first pool;
responsive to a first customer request associated with a first service performable by the first type of resource, allocating the first resource to the first customer request based upon the first contract;
using a first decentralized consensus mechanism, determining a first value associated with fulfillment of the first customer request via performance of the first service by the first resource; and
executing a first transfer of a first asset to the first farm based upon the first value.

2. The method of claim 1, comprising:
determining a second resource associated with a second farm, wherein the second resource is a second type of resource;
generating a second token for the second type of resource;
allocating the second token to the second farm;
determining a second contract between the second farm and the first pool;
responsive to a second customer request associated with a second service performable by the second type of resource, allocating the second resource of the second farm to the second customer request based upon the second contract;
using a second decentralized consensus mechanism, determining a second value associated with fulfillment of the second customer request via performance of the second service by the second resource; and
executing a second transfer of a second asset to the second farm based upon the second value.

3. The method of claim 1, comprising:
determining a second resource associated with a second farm, wherein the second resource is a second type of resource;
generating a second token for the second type of resource;
allocating the second token to the second farm;
determining a second contract between the second farm and a second pool;
responsive to a second customer request associated with a second service performable by the second type of resource, allocating the second resource of the second farm to the second customer request based upon the second contract;
using a second decentralized consensus mechanism, determining a second value associated with fulfillment of the second customer request via performance of the second service by the second resource; and
executing a second transfer of a second asset to the second farm based upon the second value.

4. The method of claim 1, comprising:
determining a second resource associated with a second farm, wherein the second resource is a second type of resource;
generating a second token for the second type of resource;
allocating the second token to the second farm;
determining a second contract of the second farm;
responsive to the first customer request also being associated with a second service performable by the second type of resource, allocating the second resource to the first customer request based upon the second contract;
using a second decentralized consensus mechanism, determining a second value associated with fulfillment of the first customer request via performance of the second service by the second resource; and
executing a second transfer of a second asset to the second farm based upon the second value.

5. The method of claim 1, comprising:
determining a second resource associated with the first farm, wherein the second resource is a second type of resource;
generating a second token for the second type of resource;
allocating the second token to the first farm;
responsive to the first customer request also being associated with a second service performable by the second type of resource, allocating the second resource to the first customer request based upon the first contract;
using the first decentralized consensus mechanism, determining a second value associated with fulfillment of the first customer request via performance of the second service by the second resource; and
executing a second transfer of a second asset to the first farm based upon the second value.

6. The method of claim 1, comprising:
determining a second contract between the first farm and a second pool;
responsive to a second customer request associated with a second service performable by the first type of resource, allocating the first resource of the first farm to the second customer request based upon the second contract;
using a second decentralized consensus mechanism, determining a second value associated with fulfillment of the second customer request via performance of the second service by the first resource; and
executing a second transfer of a second asset to the first farm based upon the second value.

7. The method of claim 1, wherein the first resource is associated with the first farm in a first defined period of time, the method comprising:
determining that the first resource is associated with a second farm in a second defined period of time;
determining a second contract between the second farm and a second pool;
responsive to a second customer request associated with a second service performable by the first type of resource in the second defined period of time, allocating the first resource to the second customer request based upon the second contract;
using a second decentralized consensus mechanism, determining a second value associated with fulfillment of the second customer request via performance of the second service by the first resource; and
executing a second transfer of a second asset to the second farm based upon the second value.

8. The method of claim 1, wherein the first contract defines a first relationship between the first farm and the first pool in a first defined period of time, the method comprising:
determining a second contract defining a second relationship between a second farm and the first pool in a second defined period of time.

9. The method of claim 1, wherein executing the first transfer of the first asset comprises at least one of:
executing a first token payment;
executing a first digital coin payment;
executing a first Non-Fungible Token (NFT) payment;
transferring a first real-world asset;
transferring a first stock share; or
executing a first Fiat payment.

10. The method of claim 2, wherein executing the second transfer of the second asset comprises at least one of:
executing a second token payment;
executing a second digital coin payment;
executing a second Non-Fungible Token (NFT) payment;
transferring a second real-world asset;
transferring a second stock share; or
executing a second Fiat payment.

11. The method of claim 1, wherein the first token comprises at least one of:
a first utility token;
a first security token;
a first payment token;
a first Non-Fungible Token (NFT);
a first stable Coin;
a first bearer token;
a first refresh token;
a first ID token;
a first JSON web token (JWT);
a first connected token; or
a first disconnected token.

12. The method of claim 1, wherein the first resource comprises a programmable device, and allocating the first resource to the first customer request comprises generating one or more commands for performing the first service and transmitting the one or more commands to the programmable device.

13. The method of claim 1, wherein the first resource comprises at least one of:
a first ground vehicle;
a first sea transport vessel;
a first air vehicle; or
a first space vehicle.

14. The method of claim 3, wherein:
the first decentralized consensus mechanism comprises a first proof of work (PoW) model; and
the second decentralized consensus mechanism comprises a second PoW model.

15. The method of claim 14, wherein:
the first PoW model is configured based upon one or more first parameters comprising at least one of:
a first risk determination function related to the first type of resource;
one or more first time-related coefficients related to the first type of resource;
a first activity time function related to the first type of resource;
a first correlation and integration function of a time available related to the first type of resource;
a first income function related to the first type of resource; or
a first customer satisfaction parameter related to the first type of resource; and
the second PoW model is configured based upon one or more second parameters comprising at least one of:
a second risk determination function related to the second type of resource;
one or more second time-related coefficients related to the second type of resource;
a second activity time function related to the second type of resource;
a second correlation and integration function of a time available second type of resource;
a second income function related to the second type of resource; or
a second customer satisfaction parameter related to the second type of resource.

16. The method of claim 1, comprising:
determining a value of one or more tokens of the first farm;
determining an income of the first farm;
determining a financing value for the first farm based upon the value of the one or more tokens of the first farm and the income of the first farm;
executing a financing transfer from a financing entity to the first farm based upon the financing value; and
providing the one or more tokens of the first farm as collateral to the financing entity.

17. The method of claim 1, comprising:
determining, via a second decentralized consensus mechanism, a first reward for a first customer from which the first customer request was received; and
executing a second transfer to the first customer based upon the first reward.

18. The method of claim 1, comprising:
prior to the first contract between the first farm and the first pool, determining, via a second decentralized consensus mechanism, a first expected revenue for the first resource in association with the first pool; and
presenting the first expected revenue to the first farm.

19. The method of claim 1, comprising:
receiving a request, from an owner of the first resource, to allocate a defined portion of the first resource to the first farm.

20. A non-transitory computer-readable medium having stored thereon processor-executable instructions that when executed cause performance of operations, the operations comprising:
determining a first resource associated with a first farm, wherein the first resource is a first type of resource;
generating a first token for the first type of resource;
allocating the first token to the first farm;
determining a first contract between the first farm and a first pool;
responsive to a first customer request associated with a first service performable by the first type of resource, allocating the first resource to the first customer request based upon the first contract;
using a first decentralized consensus mechanism, determining a first value associated with fulfillment of the first customer request via performance of the first service by the first resource; and
executing a first transfer of a first asset to the first farm based upon the first value.

21. A computing device comprising:
a processor; and
memory comprising processor-executable instructions that when executed by the processor cause performance of operations comprising:
determining a first resource associated with a first farm, wherein the first resource is a first type of resource;
generating a first token for the first type of resource;
allocating the first token to the first farm;
determining a first contract between the first farm and a first pool;
responsive to a first customer request associated with a first service performable by the first type of resource, allocating the first resource to the first customer request based upon the first contract;
using a first decentralized consensus mechanism, determining a first value associated with fulfillment of the first customer request via performance of the first service by the first resource; and
executing a first transfer of a first asset to the first farm based upon the first value.
